(19) United States
(12) Patent Application Publication
(10) Pub. No.: US 2024/0322308 A1
(43) Pub. Date: Sep. 26, 2024

(54) EXTERIOR MATERIAL, SOLID STATE BATTERY, AND ELECTRONIC DEVICE

(71) Applicant: Murata Manufacturing Co., Ltd., Nagaokakyo-shi (JP)

(72) Inventors: Isao TAMAKI, Nagaokakyo-shi (JP); Haruhiko MORI, Nagaokakyo-shi (JP); Norihide FUJIMOTO, Nagaokakyo-shi (JP); Hideki IMURA, Nagaokakyo-shi (JP)

(21) Appl. No.: 18/737,139

(22) Filed: Jun. 7, 2024

Related U.S. Application Data
(63) Continuation of application No. PCT/JP2022/039941, filed on Oct. 26, 2022.

(30) Foreign Application Priority Data
Dec. 14, 2021 (JP) 2021-202785

(51) Int. Cl. H01M 50/129

(52) U.S. Cl. CPC H01M 50/129

(57) ABSTRACT

An exterior material that includes: a metal layer; a first thermoplastic resin layer on a first principal surface side of the metal layer; and a second thermoplastic resin layer on a second principal surface side of the metal layer, in which a first melting point of the first thermoplastic resin layer and a second melting point of the second thermoplastic resin layer are both higher than 260° C.

### CROSS REFERENCE TO RELATED APPLICATIONS

The present application is a continuation of International application No. PCT/JP2022/039941, filed Oct. 26, 2022, which claims priority to Japanese Patent Application No. 2021-202785, filed Dec. 14, 2021, the entire contents of each of which are incorporated herein by reference.

### TECHNICAL FIELD

The present description relates to an exterior material, a solid state battery, and an electronic device. Specifically, the present description relates to an exterior material, a solid state battery including an exterior material, and an electronic device including an exterior material.

### BACKGROUND ART

An exterior material is provided to cover the periphery of an electronic device and protects the electronic device. Examples of the electronic device protected by the exterior material include a battery, a circuit board, a composite module, and an electronic component.

Examples of the battery include a secondary battery that can be repeatedly charged and discharged. Conventionally, a secondary battery that can be repeatedly charged and discharged has been used for various applications. For example, secondary batteries are used as power supplies for electronic devices such as smart phones and notebook computers.

In the secondary battery, a liquid electrolyte (electrolytic solution) such as an organic solvent has been conventionally used as a medium for moving ions. However, the secondary battery using the electrolytic solution has a problem such as leakage of the electrolytic solution. Therefore, the development of solid state batteries including a solid electrolyte instead of a liquid electrolyte has been advanced.
Patent Document 1: Japanese Patent No. 6179576

### SUMMARY OF THE DESCRIPTION

As a conventional exterior material, an exterior material having a laminate structure including a metal layer, resin layers located on both sides of the metal layer, and an adhesive layer located between the metal layer and the resin layers may be used. In this case, there is a possibility that the adhesiveness of the adhesive layer cannot be suitably maintained depending on the properties of the adhesive layer of the exterior material. Therefore, when the exterior material is provided to cover the periphery of an electronic device such as a solid state battery, water vapor may enter the electronic device such as a solid state battery through the adhesive layer.

The present description has been made in view of such circumstances. An object of the present description is to provide an exterior material capable of suppressing entry of water vapor, and an electronic device such as a solid state battery including the exterior material.

In an embodiment of the present description, there is provided an exterior material including: a metal layer; a first thermoplastic resin layer located on a first principal surface side of the metal layer; and a second thermoplastic resin layer located on a second principal surface side of the metal layer, in which a melting point of the first thermoplastic resin layer and a melting point of the second thermoplastic resin layer are both higher than 260° C.

Furthermore, in an embodiment of the present description, there is provided a solid state battery including: a battery element including a positive electrode layer, a negative electrode layer, and a solid electrolyte layer interposed between the positive electrode layer and the negative electrode layer; an exterior material covering the battery element; and a conducting part capable of extracting electricity from the battery element to an outside, in which the exterior material includes a metal layer, a first thermoplastic resin layer located on a first principal surface side of the metal layer, and a second thermoplastic resin layer located on a second principal surface side of the metal layer, and a melting point of the first thermoplastic resin layer and a melting point of the second thermoplastic resin layer are both higher than 260° C.

Further, an embodiment of the present description relates to an electronic device including: an electronic device; and an exterior material covering the electronic device, in which the exterior material includes a metal layer, a first thermoplastic resin layer located on a first principal surface side of the metal layer, and a second thermoplastic resin layer located on a second principal surface side of the metal layer, and a melting point of the first thermoplastic resin layer and a melting point of the second thermoplastic resin layer are both higher than 260° C.

According to the exterior material of an embodiment of the present description, entry of water vapor can be suppressed. According to the solid state battery and the electronic device of an embodiment of the present description, entry of water vapor into the solid state battery and the electronic device can be suppressed.

### BRIEF EXPLANATION OF DRAWINGS

FIG. 1 is a sectional view schematically illustrating an exterior material according to an embodiment of the present description.

FIG. 2 is a schematic view illustrating steps of manufacturing the exterior material according to an embodiment of the present description.

FIG. 3 is a sectional view schematically illustrating a solid state battery according to an embodiment of the present description.

FIG. 4 is a sectional view schematically illustrating the solid state battery according to an embodiment of the present description.

FIG. 5 is a sectional view schematically illustrating the solid state battery according to an embodiment of the present description.

FIG. 6 is a sectional view schematically illustrating an aspect of preventing entry of water vapor by the solid state battery according to an embodiment of the present description.

FIG. 7 is a sectional view schematically illustrating the solid state battery according to an embodiment of the present description.

FIG. 8 is a perspective view schematically illustrating the solid state battery according to an embodiment of the present description.

FIG. 9 is a sectional view schematically illustrating the solid state battery (expanded state) according to an embodiment of the present description.

FIG. 10 is a sectional view schematically illustrating the solid state battery according to an embodiment (with a sealant) of the present description.

FIG. 11 is a sectional view schematically illustrating a solid state battery according to another embodiment of the present description.

FIG. 12 is a sectional view schematically illustrating the solid state battery according to another embodiment of the present description.

FIG. 13 is a sectional view schematically illustrating an electronic device according to an embodiment of the present description.

FIG. 14 is a schematic diagram illustrating steps of manufacturing the solid state battery according to an embodiment of the present description.

FIG. 15 is a sectional view schematically illustrating a conventional exterior material.

FIG. 16 is a sectional view schematically illustrating a conventional solid state battery.

FIG. 17 is a perspective view schematically illustrating the conventional solid state battery.

### DESCRIPTION OF THE PREFERRED EMBODIMENTS

### [Exterior Material of Present Description]

Hereinafter, an exterior material according to an embodiment of the present description will be described in more detail. Although the description will be made with reference to the drawings as necessary, the illustrated contents are only schematically and exemplarily illustrated for the understanding of the present description, and the appearance, the dimensional ratio, and the like may be different from the actual ones.

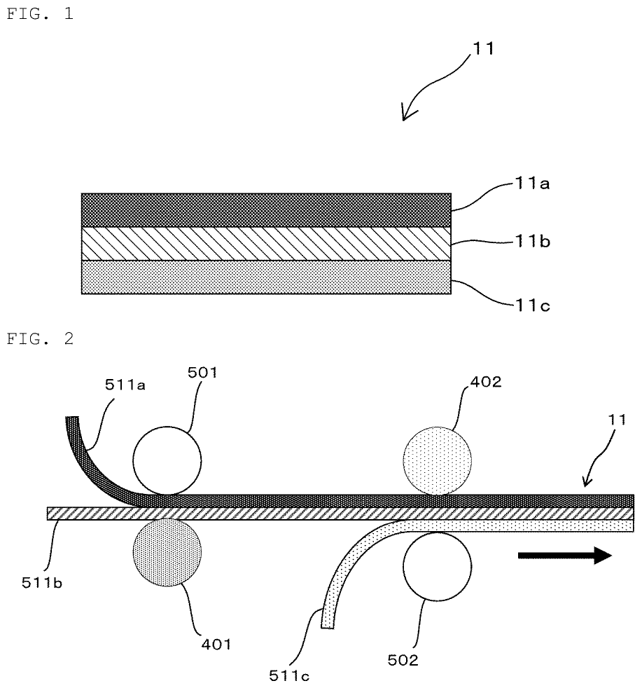

FIG. 1 is a sectional view schematically illustrating an exterior material according to an embodiment of the present description.

As illustrated in FIG. 1, an exterior material 11 according to an embodiment of the present description includes a metal layer 11b, a first thermoplastic resin layer 11a located on a first principal surface side of the metal layer 11b, and a second thermoplastic resin layer 11c located on a second principal surface side of the metal layer 11b, in which a melting point of the first thermoplastic resin layer 11a and a melting point of the second thermoplastic resin layer 11c are both higher than 260° C. Note that the term “thermoplastic resin” as used in the present specification refers to a resin that is softened by application of heat, solidified by cooling, and can reversibly repeat softening and solidification. The thermoplastic resin may be a resin having thermal adhesiveness.

Conventionally, in order to bond a resin layer and an adherend such as a metal layer, an adhesive layer has been interposed between the resin layer and the adherend. For example, a conventional exterior material 11′ illustrated in FIG. 15 includes an adhesive layer 11d′ between a resin layer 11a′ and a metal layer 11b′ (may also include an adhesive layer 11e′ between the metal layer 11b′ and a resin layer 11c′). On the other hand, in the exterior material 11 of the present description, both of the two resin layers 11a and 11c located on the first principal surface side and the second principal surface side of the metal layer 11b are resin layers having thermoplasticity and having melting points exceeding the mounting temperature upper limit value (see FIG. 1).

In this case, as compared with a conventional exterior material, due to the fact that the two thermoplastic resin layers are provided to sandwich the metal layer, and/or the properties (properties of softening by application of heat and solidifying by cooling) of each thermoplastic resin layer, the thermoplastic resin layer follows the irregularities of the surface of the metal layer by softening the resin surface by heating. As a result, the contact area between the surface of the resin layer and the surface of the metal layer increases, and in addition thereto, the functional group of the surface of the metal layer and the functional group of the thermoplastic resin layer may cause a chemical bond and/or a physical bond due to an intermolecular force between the surface of the metal layer and the thermoplastic resin layer. Thereby, two resin layers having thermoplasticity and an adherend such as a metal layer located between the resin layers can be bonded to each other without necessarily using an adhesive layer. As a result, the form of an exterior body having a laminated structure can be maintained without necessarily using an adhesive layer.

Therefore, in the exterior material in which it is essential to use the adhesive layer as in the prior art, there is a possibility that water vapor enters through the adhesive, and thus the present description can suppress entry of water vapor into the exterior material itself as compared with the conventional exterior material. As a result, when the exterior material in which entry of water vapor is suppressed is provided to cover the periphery of an electronic device such as a solid state battery, it is also possible to suppress entry of water vapor into the electronic device such as a solid state battery. In other words, the exterior material itself can have a function as a water vapor barrier film.

In an embodiment of the present description, since two resin layers having thermoplasticity and an adherend such as a metal layer located between the resin layers can be bonded to each other without necessarily using an adhesive layer, the total thickness of the exterior material can also be reduced. That is, when the exterior material is provided integrally with an electronic device such as a battery, it can contribute to reduction in the size of an integrated product itself. Reduction of the size of the integrated product itself can contribute to, for example, improvement of energy density, space saving, or the like.

In an embodiment of the present description, since an adhesive layer is not necessarily used, an application step of the adhesive layer and a curing step of the adhesive layer can be omitted. Therefore, the exterior material of an embodiment of the present description can be a low-cost exterior material.

Hereinafter, constituent elements of the exterior material according to an embodiment of the present description will be described.

### [Metal Layer]

As illustrated in FIG. 1, the metal layer 11b is a layer positioned in an intermediate layer among layers constituting the exterior material 11. In other words, the metal layer 11b is a layer sandwiched between the first thermoplastic resin layer 11a and the second thermoplastic resin layer 11c. The metal layer 11b is a layer extending in a planar shape. Since the metal layer 11b is a layer extending in a planar shape, the metal layer 11b has two principal surfaces. Specifically, the metal layer 11b extends such that the first principal surface of the metal layer 11b and the second principal surface of the metal layer 11b face each other. As the metal layer 11b used in the exterior material 11, for example, a metal foil may be used. The metal layer 11b may be a layer having substantially no permeability to water vapor and/or gas, or the like.

### [First Thermoplastic Resin Layer]

As illustrated in FIG. 1, the first thermoplastic resin layer 11a is located on the first principal surface side of the metal layer 11b. In other words, the first thermoplastic resin layer 11a is located on the first principal surface of the principal surfaces of the metal layer 11b. The term “located” as used herein may mean that the first thermoplastic resin layer 11a is provided in direct contact with the metal layer 11b, or the first thermoplastic resin layer 11a is provided indirectly on the first principal surface with the other layer interposed therebetween. In other words, it means that another layer may be provided between the first thermoplastic resin layer 11a and the metal layer, or no other layer may be provided. The first thermoplastic resin layer 11a is used for protecting the electronic device, and specifically, is used for preventing entry of water vapor from the outside (water vapor barrier layer) or for preventing damage to the electronic device. As necessary, the first thermoplastic resin layer 11a may also have chemical resistance, insulation properties, and the like.

The first thermoplastic resin layer 11a is a layer containing a thermoplastic resin as a main component. The thermoplastic resin is a resin that can be bonded to an adherend such as a metal layer by application of heat. The thermoplastic resin is a resin that is softened by application of heat, solidified by cooling, and can reversibly repeat softening and solidification. The first thermoplastic resin layer 11a may be composed of a thermoplastic resin. The first thermoplastic resin layer 11a may include a single layer or may be composed of an integrated product of two or more layers. The thermoplastic resin may be a resin having thermal adhesiveness.

The melting point of the first thermoplastic resin layer 11a is preferably higher than 260° C. The “melting point of the first thermoplastic resin layer” used in the present description may be, for example, a temperature at which the first thermoplastic resin layer 11a melts, and specifically, may be a melting point described in detail below. When the first thermoplastic resin layer 11a includes two or more layers, the melting point of a material used for these layers is preferably higher than 260° C.

### [Second Thermoplastic Resin Layer]

As illustrated in FIG. 1, the second thermoplastic resin layer 11c is located on the second principal surface side of the metal layer 11b. In other words, the second thermoplastic resin layer 11c is located on the second principal surface of the principal surfaces of the metal layer 11b. The second thermoplastic resin layer 11c is located on a principal surface side, which is different from the principal surface side on which the first thermoplastic resin layer 11a is located, of the principal surfaces of the metal layer 11b. The term “located” as used herein may mean that the second thermoplastic resin layer 11c is provided in direct contact with the metal layer 11b, or the second thermoplastic resin layer 11c is provided indirectly on the second principal surface with the other layer interposed therebetween. In other words, it means that another layer may be provided between the second thermoplastic resin layer 11c and the metal layer 11b, or no other layer may be provided. The second thermoplastic resin layer 11c is used for protecting the electronic device, and specifically, is used for preventing entry of water vapor from the outside (water vapor barrier layer) or for preventing damage to the electronic device. As necessary, the second thermoplastic resin layer 11c may also have chemical resistance, insulation properties, and the like.

The second thermoplastic resin layer 11c is a layer containing a thermoplastic resin as a main component. The thermoplastic resin used in the second thermoplastic resin layer 11c is a resin having the same characteristics as the thermoplastic resin layer used in the first thermoplastic resin. The second thermoplastic resin layer 11c may be composed of a thermoplastic resin. The second thermoplastic resin layer 11c may be a single layer or may be composed of an integrated product of two or more layers.

The melting point of the second thermoplastic resin layer 11c is preferably higher than 260° C. The “melting point of the second thermoplastic resin layer” used in the present description may be, for example, a temperature at which the second thermoplastic resin layer 11c melts, and specifically, may be a melting point described in detail below. When the second thermoplastic resin layer 11c includes two or more layers, the melting point of a material used for these layers is preferably higher than 260° C.

As the melting point of the first thermoplastic resin layer 11a and the melting point of the second thermoplastic resin layer 11c, values measured by a conventionally known method may be used. For example, as the melting point of the first thermoplastic resin layer 11a and the melting point of the second thermoplastic resin layer 11c, values determined in accordance with the method described in JIS K7121-2012 may be used.

The melting point of the first thermoplastic resin layer 11a and the melting point of the second thermoplastic resin layer 11c can be controlled by a conventionally known method. For example, the melting point of the first thermoplastic resin layer 11a and the melting point of the second thermoplastic resin layer 11c can be controlled by adjusting the molecular weight, the polymerization degree, the molecular weight distribution, the crystallinity, the copolymerization ratio, the size of the polymer crystal, and the like of a polymer constituting the thermoplastic resin.

The melting point of the first thermoplastic resin layer 11a is not particularly limited as long as the first thermoplastic resin layer 11a is not melted at a mounting temperature when an electronic device including the exterior material of the present description is mounted on a substrate or the like. From the viewpoint of further preventing the first thermoplastic resin layer 11a from melting at the mounting temperature, the melting point of the first thermoplastic resin layer 11a may be preferably 270° C. or higher, more preferably 280° C. or higher, and still more preferably 290° C. or higher. On the other hand, when the melting point of the first thermoplastic resin layer 11a is too high, the first thermoplastic resin layer 11a is less likely to be softened, so that processing becomes difficult, and a high-temperature heat source is required, so that manufacturing cost increases. From the viewpoint of improving processability and/or suppressing manufacturing cost, the melting point of the first thermoplastic resin layer 11a may be preferably 400° C. or lower, more preferably 370° C. or lower, still more preferably 350° C. or lower, and particularly preferably 330° C. or lower.

The melting point of the second thermoplastic resin layer 11c is not particularly limited as long as the second thermoplastic resin layer 11c is not melted at a mounting temperature when an electronic device including the exterior material of the present description is mounted on a substrate or the like. From the viewpoint of further preventing the second thermoplastic resin layer 11c from melting at the mounting temperature, the melting point of the second thermoplastic resin layer 11c may be preferably 270° C. or higher, more preferably 280° C. or higher, and still more preferably 290° C. or higher. On the other hand, when the melting point of the second thermoplastic resin layer 11c is too high, the second thermoplastic resin layer 11c is less likely to be softened, so that processing becomes difficult, and a high-temperature heat source is required, so that manufacturing cost increases. From the viewpoint of improving processability or suppressing manufacturing cost, the melting point of the second thermoplastic resin layer 11c may be preferably 400° C. or lower, more preferably 370° C. or lower, still more preferably 350° C. or lower, and particularly preferably 330° C. or lower.

From the viewpoint of further reducing the size of an integrated product obtained when the exterior material is integrated with an electronic device such as a battery, the thickness of the exterior material 11 may be preferably 1 μm to 500 μm, more preferably 5 μm to 300 μm, still more preferably 10 μm to 200 μm, and particularly preferably 20 μm to 150 μm.

The thickness of the metal layer 11b may be, for example, 1 μm to 200 μm. From the viewpoint of further reducing the total thickness of the exterior material 11, the thickness of the metal layer 11b may be 1 μm to 100 μm, preferably 10 μm to 100 μm, more preferably 10 μm to 50 μm, and still more preferably 20 μm to 50 μm.

From the viewpoint of further reducing the total thickness of the exterior material 11, the thickness of the first thermoplastic resin layer 11a may be preferably 1 μm to 500 μm, more preferably 2 μm to 300 μm, and still more preferably 3 μm to 100 μm.

From the viewpoint of further reducing the total thickness of the exterior material 11, the thickness of the second thermoplastic resin layer 11c may be preferably 1 μm to 500 μm, more preferably 2 μm to 300 μm, and still more preferably 3 μm to 100 μm.

In the exterior material 11 according to an embodiment of the present description, another layer may exist between the metal layer 11b and the first thermoplastic resin layer 11a located on the first principal surface side of the metal layer 11b, and still another layer may exist between the metal layer 11b and the second thermoplastic resin layer 11c located on the second principal surface side of the metal layer 11b. Such another layer and still another layer may be, for example, a water vapor barrier layer, an insulating layer, a chemical resistant layer, a heat resistant layer, or a damage preventing layer.

The exterior material 11 according to an embodiment of the present description may include a first sublayer covering the first thermoplastic resin layer 11a and may include a second sublayer covering the second thermoplastic resin layer 11c. Specifically, the first sublayer may be provided on a principal surface of the first thermoplastic resin layer 11a different from the principal surface of the first thermoplastic resin layer 11a facing or in contact with the first principal surface of the metal layer 11b. In such an embodiment, the first thermoplastic resin layer is located between the first sublayer and the metal layer. The second sublayer may be provided on a principal surface of the second thermoplastic resin layer 11c different from the principal surface of the second thermoplastic resin layer 11c facing or in contact with the second principal surface of the metal layer 11b. In such an embodiment, the second thermoplastic resin layer is located between the second sublayer and the metal layer. The first sublayer and the second sublayer may be, for example, an additional water vapor barrier layer, a chemical resistant layer, a heat resistant exterior material, or a damage resistant layer. Specifically, first sublayer and the second sublayer may be, for example, an additional metal layer or a metal plating layer formed by sputtering or the like.

As described in the above effect, the exterior material 11 according to an embodiment of the present description may not use an adhesive layer or may use an adhesive layer having a relatively small thickness from the viewpoint of suppressing entry of water vapor. When an adhesive layer is not used, there is no possibility that water vapor enters through the adhesive layer, so that the water vapor barrier property of the exterior material can be improved. By using a material having a melting point higher than 260° C., an exterior capable of withstanding solder mounting can be provided. When an adhesive having a relatively small thickness is used, the adhesive may be, for example, an adhesive capable of maintaining adhesive force before and after a mounting step.

The exterior material according to an embodiment of the present description may further adopt the following aspect.

In an embodiment of the present description, at least one resin layer of the first thermoplastic resin layer 11a and the second thermoplastic resin layer 11c may be bonded directly to the metal layer 11b.

The state where the thermoplastic resin layer and the metal layer 11b are bonded directly to each other means that the thermoplastic resin layer and the metal layer 11b are bonded directly to each other without interposing another layer between the thermoplastic resin layer and the metal layer 11b. As such an embodiment, for example, the thermoplastic resin layer and the metal layer 11b are bonded directly to each other without interposing an adhesive layer between the thermoplastic resin layer and the metal layer 11b. The term “bonding” as used herein means that, for example, in a state where two objects are in contact with each other, the two objects in contact with each other are not separated from each other unless a force is externally applied to the two objects. In a layer to be directly bonded, for example, the first thermoplastic resin layer 11a and the metal layer 11b may be bonded directly to each other, or the second thermoplastic resin layer 11c and the metal layer 11b may be bonded directly to each other. From the viewpoint of further suppressing entry of water vapor, both the first thermoplastic resin layer 11a and the second thermoplastic resin layer 11c may be bonded directly to the metal layer 11b.

The direct bonding between the thermoplastic resin layer and the metal layer 11b may be achieved by, for example, pressure bonding the thermoplastic resin layer and the metal layer 11b. The pressure bonding means that at least one of the thermoplastic resin layer and the metal layer 11b is pressurized or pressed to bond the thermoplastic resin layer and the metal layer 11b. For example, the pressure bonding may be performed by placing the first thermoplastic resin layer 11a and the metal layer 11b in an overlapping state and applying a force to sandwich the first thermoplastic resin layer 11a and the metal layer 11b in the overlapping state. The case of pressure bonding the second thermoplastic resin layer 11c and the metal layer 11b may also be performed by the same method as described above. When the thermoplastic resin layer and the metal layer 11b are bonded directly to each other, an adhesive layer may not be used. The thermoplastic resin layer itself used for the exterior material has adhesiveness. Therefore, the thermoplastic resin layer and the metal layer 11b can be bonded to each other without using an adhesive layer. Although the mechanism by which the thermoplastic resin layer itself has a bonding force is not clear, for example, it is considered that a molecular structure contributing to the bonding force included in the thermoplastic resin, a functional group in the molecule, entry of the thermoplastic resin into fine irregularities of an adherend, and the like are causes therefor.

A difference between the melting point of the first thermoplastic resin layer 11a and the melting point of the second thermoplastic resin layer 11c may be 20° C. or more. Specifically, the melting point of the first thermoplastic resin layer 11a may be higher than the melting point of the second thermoplastic resin layer 11c by 20° C. or more, and the melting point of the first thermoplastic resin layer 11a may be lower than the melting point of the second thermoplastic resin layer 11c by 20° C. or more. When the difference between the melting point of the first thermoplastic resin layer 11a and the melting point of the second thermoplastic resin layer 11c is 20° C. or more, the exterior material 11 is easily manufactured. Specifically, in a method for manufacturing the exterior material 11 described below, a thermoplastic resin layer having a relatively high melting point can be thermally laminated on the first principal surface side of the metal layer 11b, and then a thermoplastic resin layer having a relatively low melting point can be thermally laminated on the second principal surface side of the metal layer 11b.

A difference between the melting point of the first thermoplastic resin layer 11a and the melting point of the second thermoplastic resin layer 11c may be preferably 25° C. or more, more preferably 30° C. or more, still more preferably 35° C. or more, and particularly preferably 40° C. or more, from the viewpoint of further facilitating the manufacturing of the exterior material 11. Meanwhile, from the viewpoint of facilitating temperature management at the time of thermal lamination and/or cooling during manufacturing the exterior material 11, the difference between the melting point of the first thermoplastic resin layer 11a and the melting point of the second thermoplastic resin layer 11c may be 100° C. or less, preferably 80° C. or less, more preferably 70° C. or less, still more preferably 60° C. or less, and particularly preferably 50° C. or less.

Hereinafter, types of the metal layer, the first thermoplastic resin, and the second thermoplastic resin that can be used for the exterior material according to an embodiment of the present description will be described in detail.

### [Type of Metal Layer]

Examples of the metal material constituting the metal layer 11b include at least one selected from the group consisting of aluminum (or an alloy thereof), stainless steel, copper, nickel, titanium, a nickel-plated steel plate, and the like. As the metal layer 11b, a commercially available product can be used.

When aluminum (or an alloy thereof) is used for the metal layer 11b, for example, an aluminum material conventionally used may be used. When an aluminum alloy is used for the metal layer 11b, for example, an aluminum alloy or the like including the composition defined in JIS A8021 or JIS 8079 may be used.

### [Types of First Thermoplastic Resin Layer and Second Thermoplastic Resin Layer]

The thermoplastic resin used for the first thermoplastic resin layer 11a and the second thermoplastic resin layer 11c is not particularly limited as long as the melting point thereof is a temperature higher than 260° C., and may be, for example, a liquid crystal polymer, an aromatic polyester-based resin (for example, polyethylene naphthalate), an aromatic polyether ketone-based resin, a fluorine-based resin, a polyphenylene sulfide-based resin, a polyamide-based resin, a thermoplastic polyimide-based resin, a polyamideimide-based resin, a polyetherimide-based resin, a phenol-based resin, an acrylic-based resin, a polyurethane-based resin, a silicone-based resin, or a modified product thereof. A resin classified as super engineered plastic may be used. The first thermoplastic resin layer 11a and the second thermoplastic resin layer 11c may be homopolymers or copolymers of the above resins. In the first thermoplastic resin layer 11a and the second thermoplastic resin layer 11c, the resin may be used as a single product or a compound product formed by a combination of two or more kinds of resins. The first thermoplastic resin layer 11a and the second thermoplastic resin layer 11c may be a single layer or may be composed of two or more layers. As the first thermoplastic resin layer 11a and the second thermoplastic resin layer 11c, commercially available products can be used.

Among the foregoing resins, from the viewpoint of further suppressing entry of water vapor, the first thermoplastic resin layer 11a and the second thermoplastic resin layer 11c may be composed of at least one resin selected from the group consisting of a liquid crystal polymer, polyethylene naphthalate, an aromatic polyether ketone-based resin, a fluorine-based resin, a polyamide-based resin, and a polyphenylene sulfide-based resin.

The liquid crystal polymer includes a thermotropic liquid crystal polymer exhibiting liquid crystallinity in a molten state and a rheotropic liquid crystal polymer exhibiting liquid crystallinity in a solution state. In the present description, any liquid crystal polymer may be used, but a thermotropic liquid crystal polymer may be used from the viewpoint of further suppressing entry of water vapor and/or preventing melting at a reflow temperature.

Among thermotropic liquid crystal polymers, a thermotropic liquid crystal polyester (hereinafter, simply referred to as “liquid crystal polyester”) is, for example, an aromatic polyester obtained by reacting an aromatic hydroxycarboxylic acid as an essential monomer with a monomer such as an aromatic dicarboxylic acid or an aromatic diol, and exhibits liquid crystallinity at the time of melting. Typical examples thereof include a I-type liquid crystal polyester [Formula (1) below] synthesized from p-hydroxybenzoic acid (PHB), phthalic acid, and 4,4′-biphenol, a II-type liquid crystal polyester [Formula (2) below] synthesized from PHB and 2,6-hydroxynaphthoic acid, and a III-type liquid crystal polyester [Formula (3) below] synthesized from PHB, terephthalic acid, and ethylene glycol.

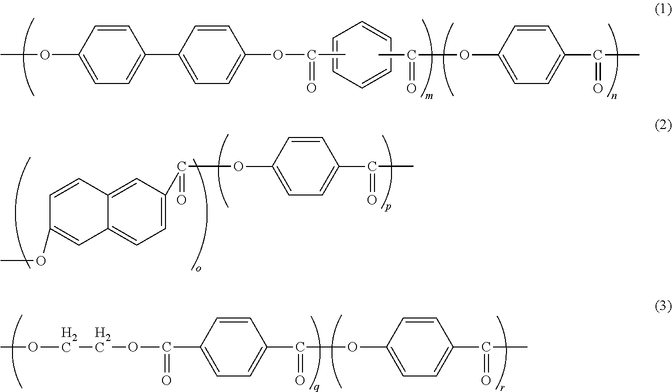

As the liquid crystal polymer used for the exterior material, the I-type liquid crystal polyester and the II-type liquid crystal polyester may be used because they are more excellent in heat resistance and hydrolysis resistance.

The aromatic polyester-based resin has an aromatic dicarboxylic acid component and a glycol component as a basic skeleton. In the present description, particularly, an aromatic polyester-based resin having a naphthalene dicarboxylic acid component and an alkylene glycol component as a basic skeleton may be used, and specifically, polyethylene naphthalate may be used. As the polyethylene naphthalate, polyethylene naphthalate obtained by reacting 2,6-naphthalene dicarboxylic acid or 2,7-naphthalene dicarboxylic acid as the naphthalene dicarboxylic acid component and ethylene glycol as the alkylene glycol component may be used.

The aromatic polyether ketone-based resin is a resin having a structure in which a ketone group and an ether group are linked to an aromatic ring. There are various types of aromatic polyether ketone-based resins depending on the arrangement order and number of aromatic rings, ketone groups, and ether groups in a constituent repeating unit, but any aromatic polyether ketone-based resin may be used. Specifically, in the present description, as the aromatic polyether ketone-based resin, for example, polyketone (PK), polyether ketone (PEK), polyether ether ketone (PEEK), polyether ketone ketone (PEKK), polyallyl ether ketone (PAEK), polyether ketone ether ketone ketone (PEKEKK), or the like may be used.

The fluorine-based resin is a resin obtained by polymerizing an olefin containing fluorine. As the fluorine-based resin, polyethylene terephthalate (PETF), perfluoroalkoxy alkane (PFA), perfluoroethylene propene copolymer (FEP), ethylene tetrafluoroethylene copolymer (ETFE), or the like may be used.

The polyphenylene sulfide is a resin containing an aromatic ring and a sulfide bond in a structural repeating unit of a polymer. Examples of the polyphenylene sulfide include linear, crosslinked, and semi-crosslinked types, and any type may be used.

The polyamide-based resin is a resin having a diamine component and a carboxylic acid component as a basic skeleton, and is a resin containing an amide bond in a structural repeating unit of a polymer. In the present description, as the polyamide-based resin, an aromatic polyamide-based resin having a relatively high melting point may be used, or a highly heat-resistant polyamide (HTPA)-based resin may be used.

As the resin used for the first thermoplastic resin layer 11a and the second thermoplastic resin layer 11c, a crystalline resin or an amorphous resin may be used. From the viewpoint of suppressing entry of water vapor, a crystalline resin that generally hardly transmits water vapor may be used.

The first thermoplastic resin layer 11a and the second thermoplastic resin layer 11c may contain a filler. As the filler, for example, carbon fiber, glass fiber, silica, talc, inorganic particles, or the like may be used. The filler may be contained, for example, in an amount of 50 vol % or less in the first thermoplastic resin layer 11a, and may be contained, for example, in an amount of 50 vol % or less in the second thermoplastic resin layer 11c.

In the exterior material according to an embodiment of the present description, the first thermoplastic resin layer 11a and the second thermoplastic resin layer 11c may be composed of the same kind of thermoplastic resin. By adopting such a configuration, since the same kind of material is handled, facilities and the like for manufacturing the exterior material 11 can be easily unified, which can contribute to improvement of manufacturing efficiency. The “kind” of the term “same kind” as used herein means a type of polymer material determined based on a repeating unit of a molecular structure of a polymer and/or a characteristic of the polymer material. For example, “the first thermoplastic resin layer 11a and the second thermoplastic resin layer 11c are composed of the same kind of thermoplastic resin” means that when a liquid crystal polymer exhibiting liquid crystallinity is selected as the first thermoplastic resin, a liquid crystal polymer exhibiting liquid crystallinity is also selected as the second thermoplastic resin. For example, when an aromatic polyester-based resin that is a polyester species containing an aromatic ring is selected as the first thermoplastic resin, it means that an aromatic polyester-based resin that is a polyester species containing an aromatic ring is selected as the second thermoplastic resin. For example, when an aromatic polyether ketone-based resin that is a polymer species containing an aromatic ring, an ether bond, and a ketone group is selected as the first thermoplastic resin, it means that an aromatic polyether ketone-based resin that is a polymer species containing an aromatic ring, an ether bond, and a ketone group is selected as the second thermoplastic resin.

As long as the first thermoplastic resin layer 11a and the second thermoplastic resin layer 11c are composed of the same kind of thermoplastic resin, the first thermoplastic resin layer 11a and the second thermoplastic resin layer 11c may have different physical properties. For example, when the first thermoplastic resin layer 11a and the second thermoplastic resin layer 11c are composed of the same kind of thermoplastic resin, the first thermoplastic resin layer 11a and the second thermoplastic resin layer 11c may have different thermal characteristics (for example, melting point, thermal expansion coefficient, and thermal conductivity), mechanical characteristics (for example, tensile strength, flexural strength, and compressive strength), resistivity, chemical resistance, and the like.

Note that, from the viewpoint of further improving manufacturing efficiency, the first thermoplastic resin layer 11a and the second thermoplastic resin layer 11c may be composed of the same material of thermoplastic resin. The term “same material” as used herein means materials in which repeating units of a molecular structure of a polymer are the same. For example, when polyethylene naphthalate composed of repeating units of naphthalene dicarboxylic acid and ethylene glycol is selected as the first thermoplastic resin, it means that polyethylene naphthalate composed of similar repeating units is also selected as the second thermoplastic resin. For example, when polyether ether ketone in which an ether bond, an ether bond, and a ketone group appear as repeating units in this order is selected as the first thermoplastic resin, it means that polyether ether ketone composed of similar repeating units is also selected as the second thermoplastic resin.

As long as the first thermoplastic resin layer 11a and the second thermoplastic resin layer 11c are composed of the same material of thermoplastic resin, the first thermoplastic resin layer 11a and the second thermoplastic resin layer 11c may have different physical properties. For example, when the first thermoplastic resin layer 11a and the second thermoplastic resin layer 11c are composed of the same material of thermoplastic resin, the first thermoplastic resin layer 11a and the second thermoplastic resin layer 11c may have different thermal characteristics (for example, melting point, thermal expansion coefficient, and thermal conductivity), mechanical characteristics (for example, tensile strength, flexural strength, and compressive strength), resistivity, chemical resistance, and the like.

### (Method for Manufacturing Exterior Material of Present Description)

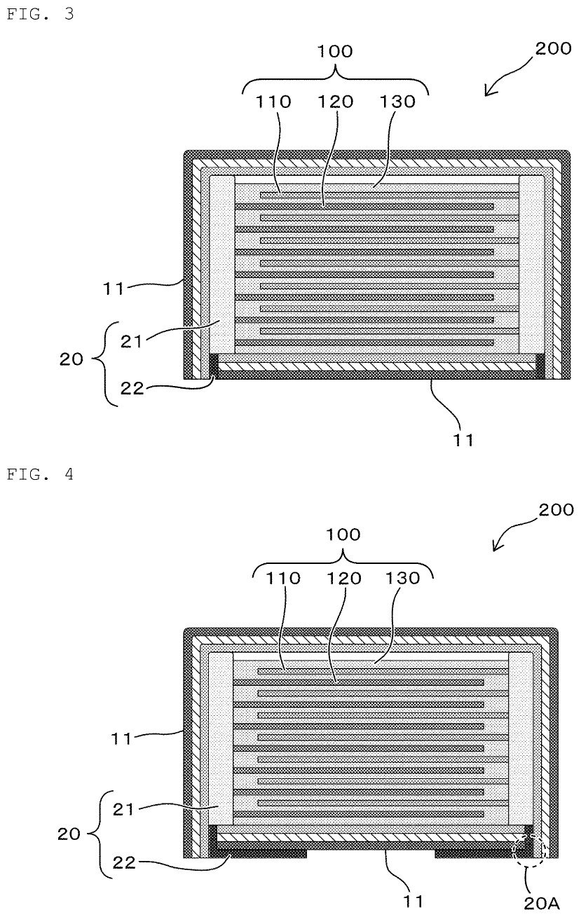

Hereinafter, a method for manufacturing an exterior material according to an embodiment of the present description will be described. The method for manufacturing an exterior material according to an embodiment of the present description roughly includes the following steps (i) and (ii) (see FIG. 2):

(i) a step of passing a metal layer 511b and a first thermoplastic resin material 511a between a first heating roll 401 and a first cooling roll 501 such that the first thermoplastic resin material 511a is located on a first principal surface of the metal layer 511b, and

(ii) a step of passing the metal layer 511b and the first thermoplastic resin material through a second heating roll 402 and a second cooling roll 502 such that the second thermoplastic resin material 511c is located on a second principal surface of the metal layer 511b.

First, the first thermoplastic resin material 511a is bonded to the first principal surface of the metal layer 511b by a thermal lamination method. Specifically, the metal layer 511b and the first thermoplastic resin material 511a are passed between the first heating roll 401 and the first cooling roll 501 such that the first principal surface of the metal layer 511b and the first thermoplastic resin material 511a overlap each other. At this time, passing is performed such that the metal layer 511b comes into contact with the first heating roll 401 and the first thermoplastic resin material 511a comes into contact with the first cooling roll 501. As a result, the first thermoplastic resin material 11a in the portion in contact with the heated metal layer 511b is softened, and the softened first thermoplastic resin material 511a is bonded (thermally fused) to the metal layer 511b. Thereafter, an integrated product of the metal layer 511b and the first thermoplastic resin material 511a is obtained from between the first heating roll 401 and the first cooling roll 501.

Next, in the integrated product of the metal layer 511b and the first thermoplastic resin material 511a, the second thermoplastic resin material 511c is bonded to the remaining second principal surface of the metal layer 511b by a thermal lamination method. Specifically, the metal layer 511b and the second thermoplastic resin material 511c are passed between the second heating roll 402 and the second cooling roll 502 such that the remaining second principal surface of the metal layer 511b and the second thermoplastic resin material 511c overlap each other. As a result, the second thermoplastic resin material 511c in the portion in contact with the heated metal layer 511b is softened, and the softened second thermoplastic resin material 511c is bonded (thermally fused) to the metal layer 511b. At this time, passing is performed such that the metal layer 511b comes into contact with the second heating roll 402 and the second thermoplastic resin material 511c comes into contact with the second cooling roll 502. The exterior material 11 according to an embodiment of the present description is obtained from between the rolls of the second heating roll 402 and the second cooling roll 502.

In the present description, the melting point of a thermoplastic resin material to be thermally fused first is preferably higher than the melting point of a thermoplastic resin material to be thermally fused next by 20° C. or more. Note that the thermoplastic resin material to be thermally fused first is referred to as a first thermoplastic resin material, and the thermoplastic resin material to be thermally fused next is referred to as a second thermoplastic resin material. That is, the melting point of the first thermoplastic resin material is preferably higher than the melting point of the second thermoplastic resin material. More preferably, the melting point of the first thermoplastic resin material may be higher than the melting point of the second thermoplastic resin material by 20° C. or more.

According to the manufacturing method, when a thermoplastic resin material having a relatively low melting point is thermally laminated on the second principal surface side of the metal layer 511b later, a thermoplastic resin material having a relatively high melting point, which has been thermally laminated on the first principal surface side of the metal layer 511b in advance, cannot be softened, and adhesion to the metal layer can be maintained. For this reason, a thermoplastic resin material having a relatively high melting point can be thermally laminated on the first principal surface side of the metal layer 511b, and then a thermoplastic resin material having a relatively low melting point can be thermally laminated on the second principal surface side of the metal layer 511b. Note that in the foregoing aspect, it is preferable that the first heating roll 401 thermally laminating the metal layer and the resin material in advance has a temperature higher than that of the subsequent second heating roll 402.

Note that, when the adhesive layer is used, the adhesive layer may be previously provided in the metal layer 511b and/or the thermoplastic resin layer.

The temperature of the first heating roll 401 is not particularly limited as long as the metal layer 511b and the first thermoplastic resin material 511a can be thermally fused, and may be, for example, 200° C. to 400° C., preferably 200° C. to 350° C., more preferably 230° C. to 350° C., still more preferably 230° C. to 330° C., and particularly preferably 230° C. to 310° C.

The temperature of the second heating roll 402 is not particularly limited as long as the metal layer 511b and the second thermoplastic resin material 511c can be thermally fused, and may be, for example, 200° C. to 400° C., preferably 200° C. to 350° C., more preferably 230° C. to 350° C., still more preferably 230° C. to 330° C., and particularly preferably 230° C. to 310° C.

### [Electronic Device]

Hereinafter, an electronic device to which the exterior material according to an embodiment of the present description can be applied will be described. Although the description will be made with reference to the drawings as necessary, the illustrated contents are only schematically and exemplarily illustrated for the understanding of the present description, and the appearance, the dimensional ratio, and the like may be different from the actual ones.

The electronic device to which the exterior material according to an embodiment of the present description can be applied is not particularly limited except that the exterior material according to an embodiment of the present description is used. Examples of the electronic device as used herein include a circuit board, a composite module, a battery, and an electronic component. Examples of the battery include a secondary battery, particularly a solid state battery. Examples of the electronic component include a capacitor, a resistor, a coil, a diode, a filter, an oscillator, and/or a transistor. Electronic device elements and the like (for example, in the case of a battery, referring to a terminal, an electrode, a separator, an electrolytic solution, or the like, and for example, in the case of a capacitor, referring to an electrode, a dielectric, a terminal, or the like) other than the exterior material are not particularly limited as long as they are applied to an electronic device. For example, such an electronic device element may be those conventionally used.

In an embodiment of the present description, an electronic device and an exterior material covering the electronic device are included. The exterior material includes a metal layer, a first thermoplastic resin layer located on a first principal surface side of the metal layer, and a second thermoplastic resin layer located on a second principal surface side of the metal layer, in which a melting point of the first thermoplastic resin layer and a melting point of the second thermoplastic resin layer are both higher than 260° C.

As described in the characteristics of the exterior material, the exterior material according to an embodiment of the present description can suppress entry of water vapor into the exterior material itself. As a result, when the exterior material in which entry of water vapor is suppressed is provided to cover the periphery of an electronic device, it is also possible to suppress entry of water vapor into the electronic device.

In an embodiment of the present description, since two resin layers having thermoplasticity and an adherend such as a metal layer located between the resin layers can be bonded to each other without necessarily using an adhesive layer, the total thickness of the exterior material can also be reduced. That is, when the exterior material is provided integrally with an electronic component or an electronic device, it can contribute to reduction in the size of an integrated product itself. Reduction of the size of the integrated product itself can contribute to space saving or the like.

In an embodiment of the present description, since an adhesive layer is not necessarily used, an application step of the adhesive layer and a curing step of the adhesive layer can be omitted. It is possible to provide an electronic device that can be solder-mounted without using an expensive ceramic package. Therefore, the electronic device of an embodiment of the present description can be a low-cost electronic device.

### [Solid State Battery]

Hereinafter, a battery, particularly a solid state battery among the electronic devices will be taken as an example, and a case where the exterior material according to an embodiment of the present description is applied to the solid state battery will be described in detail. Specifically, the exterior material is applied to cover the battery element of the solid state battery. In this case, since the internal battery elements are protected from the external environment, the solid state battery can be packaged as a whole. That is, a solid state battery with an exterior material can also be referred to as a solid state battery package. Note that FIGS. 3 to 12 schematically illustrate a form in which the exterior material according to an embodiment of the present description covers the battery element 100, but when the exterior material according to an embodiment of the present description is applied to an electronic device other than the solid state battery, the battery element 100 in the above drawings may be used as an electronic device element.

The solid state battery to which the exterior material according to an embodiment of the present description is applied is not particularly limited except that the exterior material according to an embodiment of the present description is used. Specifically, battery elements and the like (such as an electrode, a solid electrolyte, and a conductive part) other than the exterior material are not particularly limited as long as they are applied to a solid state battery. For example, such a battery element may be those conventionally used.

### (Basic Configuration of Solid State Battery)

Hereinafter, the basic configuration of the solid state battery will be first described. The solid state battery includes at least electrode layers of a positive electrode and a negative electrode, and a solid electrolyte. Specifically, the solid state battery includes a battery element including a battery constituent unit including a positive electrode layer, a negative electrode layer, and a solid electrolyte interposed therebetween.

The “solid state battery” referred to in the present description refers to a battery whose constituent elements are composed of a solid in a broad sense, and refers to an all-solid state battery whose battery constituent elements (particularly preferably all battery constituent elements) are composed of a solid in a narrow sense. In a preferred aspect, the solid state battery in the present description is a laminated solid state battery configured such that layers constituting a battery constituent unit are laminated with each other, and preferably, such layers may be composed of a sintered body. Note that the “solid state battery” includes not only a so-called “secondary battery” capable of repeating charging and discharging but also a “primary battery” capable of only discharging. According to a preferred aspect of the present description, the “solid state battery” is a secondary battery. The “secondary battery” is not excessively limited by its name, and may include, for example, a power storage device and the like.

The term “sectional view” as used in the present specification refers to a state when viewed from a direction substantially perpendicular to a thickness direction of a battery element constituting the solid state battery. The terms “up-down direction” and “left-right direction” directly or indirectly used in the present specification respectively correspond to the up-down direction and the left-right direction in the drawings. Unless otherwise specified, the same symbols or signs shall denote the same members or sites or the same meanings. According to a preferred aspect, it can be understood that the downward direction in the vertical direction (that is, the direction in which gravity acts) corresponds to a “downward direction”, whereas the opposite direction corresponds to an “upward direction”.

In the solid state battery, each layer constituting the solid state battery may be formed by firing, and the positive electrode layer, the negative electrode layer, the solid electrolyte, and the like may form a sintered layer. Preferably, the positive electrode layer, the negative electrode layer, and the solid electrolyte are integrally fired with each other, and thus, the battery element may form an integrally sintered body.

The positive electrode layer is an electrode layer containing at least a positive electrode active material. The positive electrode layer may further contain a solid electrolyte. For example, the positive electrode layer is composed of a sintered body including at least positive electrode active material particles and solid electrolyte particles. In one aspect, the positive electrode layer is composed of a sintered body substantially including only positive electrode active material particles and solid electrolyte particles. In contrast, the negative electrode layer is an electrode layer containing at least a negative electrode active material. The negative electrode layer may further contain a solid electrolyte. For example, the negative electrode layer is composed of a sintered body including at least negative electrode active material particles and solid electrolyte particles. In one aspect, the negative electrode layer is composed of a sintered body substantially including only negative electrode active material particles and solid electrolyte particles.

The positive electrode active material and the negative electrode active material are substances involved in accepting and donating electrons in the solid state battery. Ions move (or conduct) between the positive electrode layer and the negative electrode layer through the solid electrolyte to accept and donate electrons, whereby charging and discharging are performed. The positive electrode layer and the negative electrode layer may be particularly layers capable of occluding and releasing a lithium ion or a sodium ion. That is, the solid state battery may be an all-solid-state secondary battery in which lithium ions or sodium ions move between the positive electrode layer and the negative electrode layer with the solid electrolyte interposed therebetween to charge and discharge the battery.

### (Positive Electrode Active Material)

Examples of the positive electrode active material included in the positive electrode layer include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compound having an olivine-type structure include Li₃Fe₂(PO₄)₃, LiFePO₄, and/or LiMnPO₄. Examples of the lithium-containing layered oxide include LiCoO₂ and LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄. The types of the lithium compounds are not particularly limited, and may be regarded as, for example, a lithium-transition metal composite oxide and a lithium-transition metal phosphate compound. The lithium-transition metal composite oxide is a generic term for oxides containing lithium and one or two or more transition metal elements as constituent elements, and the lithium transition metal phosphate compound is a generic term for phosphate compounds containing lithium and one or two or more transition metal elements as constituent elements. The types of transition metal elements are not particularly limited and are, for example, cobalt (Co), nickel (Ni), manganese (Mn), iron (Fe), and the like.

Examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, a sodium-containing oxide having a spinel-type structure, and the like. For example, in the case of the sodium-containing phosphate compounds, examples thereof include at least one selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, Na₄Fe₃(PO₄)₂(P₂O₇), and NaFeO₂ as a sodium-containing layered oxide.

In addition to this, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

### (Negative Electrode Active Material)

Examples of the negative electrode active material contained in the negative electrode layer include at least one selected from the group consisting of an oxide containing at least one element selected from the group consisting of Ti, Si, Sn, Cr, Fe, Nb, and Mo, a carbon material such as graphite, a graphite-lithium compound, a lithium alloy, a lithium-containing phosphate compound having a NASICON-type structure, a lithium-containing phosphate compound having an olivine-type structure, and a lithium-containing oxide having a spinel-type structure. Examples of the lithium alloys include Li—Al. Examples of the lithium-containing phosphate compounds that have a NASICON-type structure include Li₃V₂(PO₄)₃ and/or LiTi2(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

Examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like. Note that, in the solid state battery of the present description according to a preferred aspect, the positive electrode layer and the negative electrode layer may be made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

The positive electrode layer and/or the negative electrode layer may further contain a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

Note that, in the solid state battery of the present description according to a preferred aspect, the positive electrode layer and the negative electrode layer are made of the same material. In the solid state battery of the present description, the positive electrode layer and the negative electrode layer may be made of the same material (for example, in such a case, the positive electrode active material and the negative electrode active material may be the same kind).

### (Solid Electrolyte)

The solid electrolyte is a material capable of conducting lithium ions. In particular, the solid electrolyte constituting a battery constituent unit in the solid state battery forms a layer capable of conducting lithium ions between the positive electrode layer and the negative electrode layer. Note that the solid electrolyte may be provided at least between the positive electrode layer and the negative electrode layer. That is, the solid electrolyte may also exist around the positive electrode layer and/or the negative electrode layer so as to protrude from between the positive electrode layer and the negative electrode layer. A specific solid electrolyte may be, for example, an oxide-based solid electrolyte, and examples thereof include a lithium-containing phosphate compound having a NASICON-type structure, an oxide having a perovskite structure, an oxide having a garnet-type or garnet-type similar structure, and an oxide glass ceramic-based lithium ion conductor. Examples of the lithium-containing phosphate compound having a NASICON-type structure include LiₓM_{y}(PO₄)₃ (1≤x≤2, 1≤y≤2, and M is at least one selected from the group consisting of Ti, Ge, Al, Ga, and Zr). Examples of the lithium-containing phosphate compound having a NASICON-type structure include Li_{1.2}Al_{0.2}Ti_{1.8}(PO₄)₃. Examples of the oxide having a perovskite structure include La_{0.55}Li_{0.35}TiO₃. Examples of the oxides that have a garnet-type or garnet-type similar structure include Li₇La₃Zr₂O₁₂. As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

Examples of the solid electrolyte capable of conducting sodium ions include a sodium-containing phosphate compound having a NASICON-type structure, an oxide having a perovskite structure, and an oxide having a garnet-type or garnet-type similar structure. Examples of the sodium-containing phosphate compound having a NASICON-type structure include NaxMy(PO₄)₃ (1≤x≤2, 1≤y≤2, and M is at least one selected from the group consisting of Ti, Ge, Al, Ga, and Zr).

The solid electrolyte may include a sintering aid. The sintering aid included in the solid electrolyte may be selected from, for example, the same materials as the sintering aids, which can be included in the positive electrode layer/the negative electrode layer.

A thickness of the solid electrolyte layer is not particularly limited, and may be, for example, 1 μm to 15 μm, particularly 1 μm to 5 μm.

### (Positive Electrode Current Collecting Layer and Negative Electrode Current Collecting Layer)

The positive electrode layer and the negative electrode layer may each include a positive electrode current collecting layer and a negative electrode current collecting layer. Each of the positive electrode current collecting layer and the negative electrode current collecting layer may have a form of a foil, but may have a form of a sintered body from the viewpoint of reducing the manufacturing cost of the solid state battery by integral firing and reducing the internal resistance of the solid state battery. As a positive electrode current collector constituting the positive electrode current collecting layer and a negative electrode current collector constituting the negative electrode current collecting layer, it is preferable to use a material having high electrical conductivity, and for example, silver, palladium, gold, platinum, aluminum, copper, nickel, or the like may be used. In particular, copper may be used because it hardly reacts with the positive electrode active material, the negative electrode active material, and the solid electrolyte material, and has an effect of reducing the internal resistance of the solid state battery. When the positive electrode current collecting layer and the negative electrode current collecting layer have the form of the sintered body, the positive electrode current collector layer and the negative electrode current collector layer may be composed of a sintered body containing a conductive material and a sintering aid. The conductive material contained in the positive electrode current collecting layer and the negative electrode current collecting layer may be selected from, for example, materials similar to the conductive material that can be contained in the positive electrode layer and the negative electrode layer. The sintering aid contained in the positive electrode current collecting layer and the negative electrode current collecting layer may be selected from, for example, materials similar to the sintering aid that can be contained in the positive electrode layer/the negative electrode layer. Note that, in the solid state battery, the positive electrode current collecting layer and the negative electrode current collecting layer are not essential, and a solid state battery in which such a positive electrode current collecting layer and a negative electrode current collecting layer are not provided is also conceivable. That is, the solid state battery in the present description may be a solid state battery without a current collector layer.

Thicknesses of the positive electrode layer and the negative electrode layer are not particularly limited, but may be, for example, 2 μm to 50 μm, particularly 5 μm to 30 μm, independently of each other.

The solid state battery, in particular the battery element, is generally provided with terminals (for example, external electrodes). In particular, an end face electrode is provided on a side surface of the battery element. More specifically, an end face electrode on the positive electrode side connected to the positive electrode layer and an end face electrode on the negative electrode side connected to the negative electrode layer are provided. Such end face electrodes may contain a material having high electrical conductivity. The specific materials of the end face electrodes are to be considered not particularly limited, but examples thereof include at least one selected from the group consisting of silver, gold, platinum, aluminum, copper, tin, and nickel. Furthermore, a terminal called a tab lead for extracting generated electricity to the outside is provided at an end part of each of the end face electrodes. The material of the tab lead may include a material having a high electrical conductivity as with the end face electrode. The specific materials of the tab lead are to be considered not particularly limited, but examples thereof include at least one selected from the group consisting of silver, gold, platinum, aluminum, copper, tin, and nickel.

### (Characteristic Part of Solid State Battery of Present Description)

The solid state battery to which the exterior material according to an embodiment of the present description is applied may include a battery element including a positive electrode layer, a negative electrode layer, and a solid electrolyte layer interposed between the positive electrode layer and the negative electrode layer, an exterior material covering the battery element, and a conducting part capable of extracting electricity from the battery element to an outside. The exterior material includes a metal layer, a first thermoplastic resin layer located on a first principal surface side of the metal layer, and a second thermoplastic resin layer located on a second principal surface side of the metal layer, in which a melting point of the first thermoplastic resin layer and a melting point of the second thermoplastic resin layer are both higher than 260° C., that is, the exterior material of the present description described above.

As described in the characteristics of the exterior material, the exterior material according to an embodiment of the present description can suppress entry of water vapor into the exterior material itself. As a result, when the exterior material in which entry of water vapor is suppressed is provided to cover the periphery of a solid state battery, it is also possible to suppress entry of water vapor into the solid state battery.

In an embodiment of the present description, since two resin layers having thermoplasticity and an adherend such as a metal layer located between the resin layers can be bonded to each other without necessarily using an adhesive layer, the total thickness of the exterior material can also be reduced. That is, when the exterior material is provided integrally with a solid state battery, it can contribute to reduction in the size of an integrated product itself. Reduction of the size of the integrated product itself can contribute to space saving or the like.

In an embodiment of the present description, since an adhesive layer is not necessarily used, an application step of the adhesive layer and a curing step of the adhesive layer can be omitted. Therefore, the solid state battery of an embodiment of the present description can be a low-cost solid state battery.

The form in which the exterior material covers the solid state battery is not particularly limited, and a conventionally adopted form can be adopted. In any form, the solid state battery obtained by integrating the exterior material and the battery element can exhibit the above effects of the present description. As an aspect in which the exterior material of the present description covers the battery element, for example, the following embodiments can be adopted.

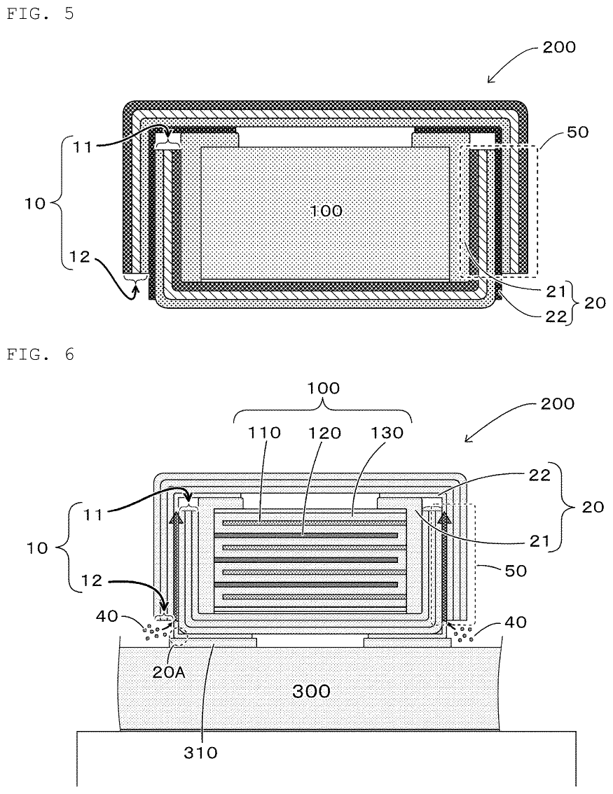

As illustrated in FIGS. 3 and 4, a first embodiment is an embodiment in which the exterior material is composed of a continuous single structure, and the exterior material of the single structure surrounds a battery element. As illustrated in FIGS. 5 to 12, a second embodiment is an embodiment in which the exterior material is an exterior composite including a first exterior material and a second exterior material, and the exterior composite surrounds a battery element.

### First Embodiment

FIG. 3 is a sectional view schematically illustrating the solid state battery according to an embodiment of the present description. FIG. 4 is a sectional view schematically illustrating the solid state battery according to an embodiment of the present description.

From the viewpoint of surface mounting of the solid state battery, for example, an embodiment as illustrated in FIG. 3 may be adopted. FIG. 3 illustrates a solid state battery 200 in which the battery element 100 is covered with the single exterior material 11 and a conducting part 20 including an end face electrode 21 and a tab lead 22 is provided. The end face electrode 21 is connected to one end part of the tab lead 22, and the other end part of the tab lead 22 is exposed to the outside. The solid state battery 200 of FIG. 3 can be surface-mounted on a substrate via the exposed end part of the tab lead 22.

In one aspect, as illustrated in FIG. 4, the conducting part 20 (tab lead 22) may be extended to the outside, and the tab lead 22 of the extended conducting part 20 may be provided along the contour surface of the battery element 100. In other words, the tab lead 22 of the conducting part 20 and the exterior material 11 may be provided along the contour surface of the battery element 100.

In the present specification, the “contour surface of the battery element 100” means a surface that defines the shape or appearance of the battery element 100. In the present specification, “the tab lead 22 of the conducting part 20 and the exterior material 11 are provided along the contour surface of the battery element 100” means a state where the tab lead 22 of the conducting part 20 and the exterior material 11 are provided substantially parallel to an extending direction of the contour surface of the battery element 100.

That is, the tab lead 22 of the conducting part 20 and the exterior material 11 may extend in substantially the same direction as the extending direction of the contour surface of the battery element 100. In the present specification, the “extending direction of the contour surface of the battery element 100” means a direction in which the contour surface advances in the longitudinal direction. The conducting part 20 and the exterior material 11 only need to extend at least at a glance in substantially the same direction as the extending direction of the contour surface of the battery element 100, and the conducting part 20 and the exterior material 11 do not necessarily need to extend in exactly the same direction as the extending direction of the contour surface of the battery element 100. For example, due to a positional relationship among the conducting part 20, the exterior material 11, and the battery element 100, there may be a part where a part of the conducting part 20 and a part of the exterior material 11 do not extend substantially in the same direction and parallel to the extending direction of the contour surface of the battery element 100.

By forming the tab lead 22 of the conducting part 20 along the contour of the battery element 100, the conducting part 20 of the solid state battery 200 illustrated in FIG. 4 can increase the contact area with the substrate in surface mounting. When the contact area between the conducting part 20 and the substrate is large, the solid state battery 200 is more easily surface-mounted on the substrate more firmly.

In one aspect, an extended part (corresponding to the tab lead 22) of the conducting part 20 to the outside may include a bent part 20A. The bent part herein means a bent part. The form of bending is not particularly limited, and for example, as illustrated in FIG. 4, in a form in which the conducting part 20 includes the end face electrode 21 and the tab lead 22, the extended part of the conducting part 20 to the outside means a bent part when the extended part has a right angle portion. Alternatively, the extended part to the outside of the conducting part 20 may be bent so as to have a part drawing an arc (curved shape), and specifically, may be bent along a surface of the exterior material 11.

The extended part (corresponding to the tab lead 22) of the conducting part 20 to the outside is connected to an electronic substrate or the like when the solid state battery 200 according to an embodiment of the present description is surface-mounted. At that time, the extended part (corresponding to the tab lead 22) of the conducting part 20 to the outside can be formed in a bent form according to a mounting area of the solid state battery 200 according to an embodiment of the present description, a positional relationship between the solid state battery 200 and the electronic substrate, or the like, and a connection method between the solid state battery 200 and the electronic substrate, or the like.

The length of the conducting part 20 extended to the outside is not particularly limited as long as electricity can be taken out from the conducting part 20. The end part of the conducting part 20 (specifically, the tab lead 22) along the contour of the battery element 100 may be provided on the upper surface side or the lower surface side of the solid state battery 200, for example, the lower surface side. As a result, the solid state batteries 200 can be mounted on the electronic substrate in the same row, and the overall surface mounting area can be further reduced. Furthermore, from the viewpoint of further reducing the overall surface mounting area and more reliably achieving the surface mounting of the solid state battery 200, at least a part of the extended part of the conducting part 20 may be in “surface” contact with a surface of the electronic substrate. By making contact with the “surface”, a contact area between the conducting part 20 and the electronic substrate can be increased. As illustrated in FIG. 4, such a form can be achieved by providing a bent part in the extended part of the conducting part 20 such that at least a part of the extended part of the conducting part 20 to the outside is substantially parallel to the surface of the electronic substrate.

Note that the end part of the extended conducting part 20 is not necessarily fixed to the exterior material 11, and may be a free end at which the end part can freely move. In this regard, from the viewpoint of reducing the mounting area, in one aspect, a form in which at least the end part of the extended conducting part 20 is fixed to the exterior material 11 may be employed.

By adopting such a form, the end part of the extended conducting part 20 is brought into close contact along the side surface of the battery element 100, and the close contact state can be maintained.

Moreover, since the close contact state is maintained, it is possible to suitably prevent the end part of the extended conducting part 20 from being bent and deformed when a force is applied from the outside to the end part of the extended conducting part 20. As a result, the solid state battery 200 can be appropriately surface-mounted on the electronic substrate.

A method of fixing the end part of the extended conducting part 20 to the exterior material 11 is not particularly limited. For example, the end part of the extended conducting part 20 may be fixed to the exterior material 11 by thermal fusion. For example, the end part of the extended conducting part 20 may be fixed to the exterior material 11 by using an adhesive. The form of the adhesive is, for example, liquid, paste, sheet, solid, or powder. The type of the adhesive is, for example, an aqueous adhesive, a chemical reaction adhesive, a solvent adhesive, or a hot melt adhesive. The adhesive is not particularly limited as long as the adhesive force of the adhesive does not change before and after a reflow step. For example, examples of a material of the adhesive include at least one selected from the group consisting of a silicone-based resin, an acrylic-based resin, an epoxy-based resin, a urethane-based resin, and the like.

Furthermore, during charging and discharging of the solid state battery 200, as ions move in the solid electrolyte layer between the positive electrode layer and the negative electrode layer, the active material contained in each electrode layer may expand and contract along the lamination direction. In particular, when the active material, that is, the electrode layer expands along the lamination direction, tensile stress acting in an upward direction and tensile stress acting in a downward direction are generated due to this. In this regard, according to the present aspect, when the solid state battery 200 is surface-mounted on the electronic substrate, a minute space can be provided between the solid state battery 200 and the electronic substrate. The presence of such a space also makes it possible to receive an expanding part of the solid state battery 200 due to expansion of the electrode layer along the lamination direction.

The exterior material 11 may be fixed to the end face electrode 21 by thermal fusion. Specifically, the first thermoplastic resin layer 11a or the second thermoplastic resin layer 11c of the exterior material 11 may be thermally fused to the end face electrode 21. In this case, the difference between the melting point of the first thermoplastic resin layer 11a and the melting point of the second thermoplastic resin layer 11c may be 20° C. or more. In such an aspect, the melting point of the second thermoplastic resin layer 11c may be lower than the melting point of the first thermoplastic resin layer 11a. By adopting such a form, it is easy to thermally fuse only the second thermoplastic resin layer 11c having a relatively low melting point to the end face electrode 21.

### Second Embodiment

From the viewpoint of surface mounting of the solid state battery, for example, an embodiment as illustrated in FIG. 5 may be adopted. Specifically, in the solid state battery illustrated in FIG. 5, an exterior composite including two or more of the exterior materials is provided, the two or more exterior materials each include a first exterior material and a second exterior material, an overlapping region in which the first exterior material and the second exterior material overlap each other is formed, and the conducting part is extended from the overlapping region to the outside.

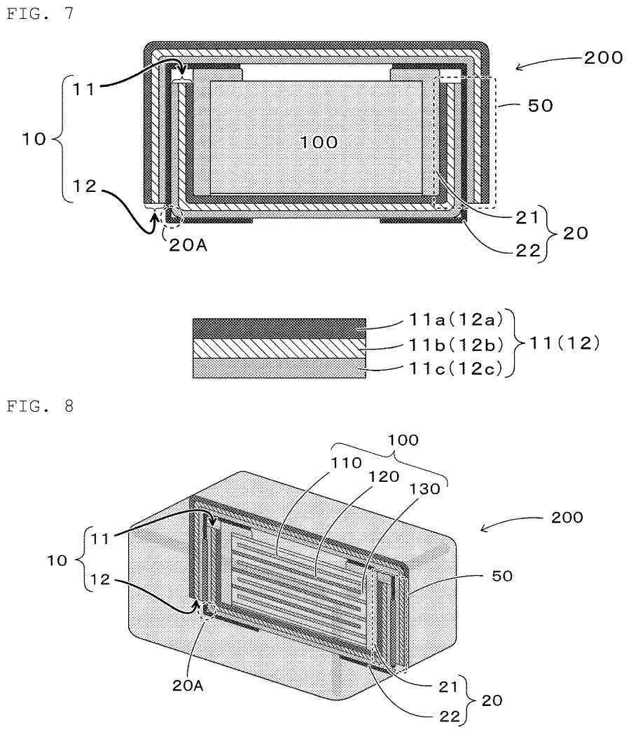

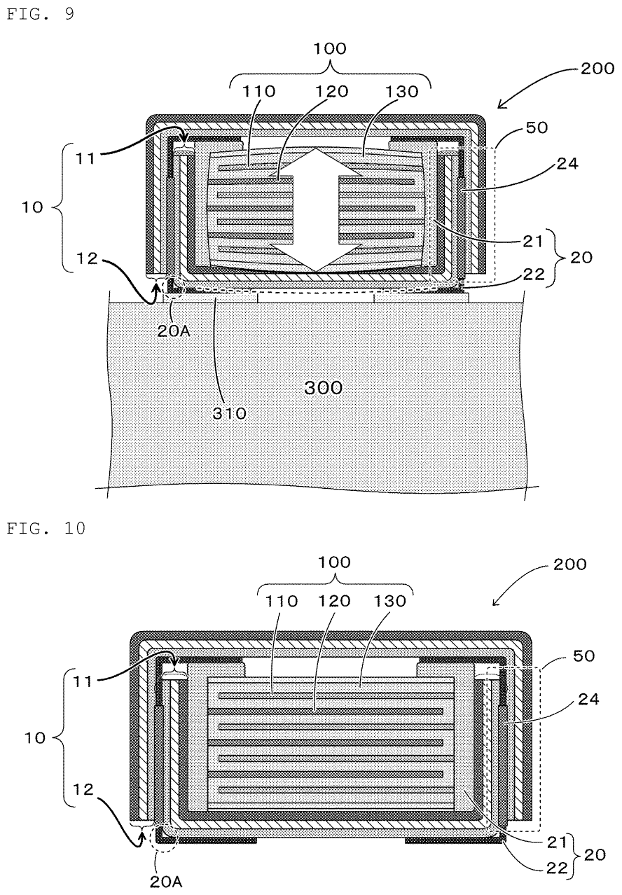

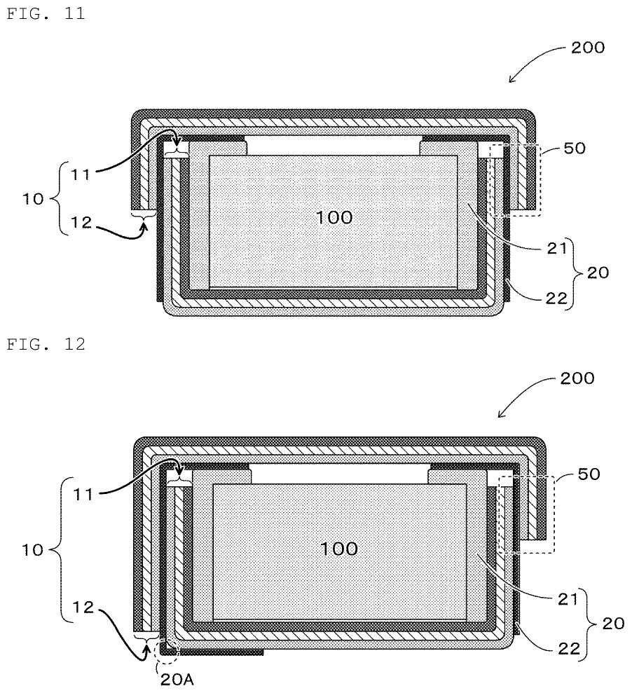

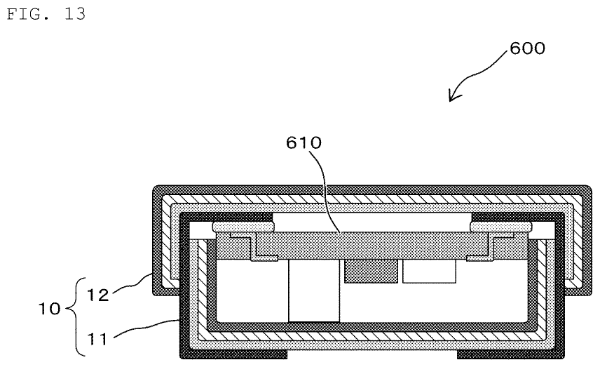

FIG. 5 is a sectional view schematically illustrating the solid state battery according to an embodiment of the present description. FIG. 6 is a sectional view schematically illustrating an aspect of preventing entry of water vapor by the solid state battery according to an embodiment of the present description. FIG. 7 is a sectional view schematically illustrating the solid state battery according to an embodiment of the present description. FIG. 8 is a perspective view schematically illustrating the solid state battery according to an embodiment of the present description. FIG. 9 is a sectional view schematically illustrating the solid state battery (expanded state) according to an embodiment of the present description. FIG. 10 is a sectional view schematically illustrating the solid state battery according to an embodiment (with a sealant) of the present description. FIG. 11 is a sectional view schematically illustrating a solid state battery according to another embodiment of the present description. FIG. 12 is a sectional view schematically illustrating the solid state battery according to another embodiment of the present description.

The term “exterior composite” as used in the present specification refers to one (constituent) formed by collecting or combining two or more exterior materials, and may also be referred to as an exterior assembly. The term “composite” as used in the present specification refers to a state where two or more kinds are gathered into one. The term “conducting part” as used in the present specification refers to a generic term for members that contribute to electrical extraction, such as an end face electrode 21 provided on the battery element 100 and a tab lead 22 connected to the end face electrode 21. That is, the conducting part 20 includes the end face electrode 21 provided on the battery element 100 and the tab lead 22 connected to the end face electrode 21.

That is, in an embodiment of the present description, the battery element 100 is covered with an exterior composite 10 formed by combining two or more exterior materials. In other words, the exterior composite 10 surrounds the battery element 100. As an example, as illustrated in FIG. 5, the exterior composite 10 is composed of a first exterior material 11 and a second exterior material 12. Moreover, in an embodiment of the present description, an overlapping region 50 in which the first exterior material 11 and the second exterior material 12 overlap each other is formed in the exterior composite 10, and the conducting part 20 is extended from the overlapping region 50 to the outside.

The first exterior material 11 includes the metal layer 11b, the first thermoplastic resin layer 11a, and the second thermoplastic resin layer 11c. The second exterior material 12 includes a metal layer 12b, a first thermoplastic resin layer 12a, and a second thermoplastic resin layer 12c. Each layer constituting the first exterior material 11 and each layer constituting the second exterior material 12 may be the same.

Note that, for the overlapping region 50, a positional relationship between the first exterior material 11 and the second exterior material 12 is not particularly limited, and for example, the second exterior material 12 may be positioned outside the first exterior material 11, and the first exterior material 11 may be positioned outside the second exterior material 12. In other words, in the overlapping region 50, the first exterior material 11 may be provided on a side relatively proximal to the battery element 100, and the second exterior material 12 may be provided on a side relatively distal to the battery element 100. Alternatively, in the overlapping region 50, the second exterior material 12 may be provided on a side relatively proximal to the battery element 100, and the first exterior material 11 may be provided on a side relatively distal to the battery element 100. The overlapping region 50 may be composed of more than two exterior materials. For example, in the mode illustrated in FIG. 5, the overlapping region 50 is configured by two layers of the first exterior material 11 and the second exterior material 12, but for example, the overlapping region may also be configured using a third exterior material and a fourth exterior material.

The term “overlapping region” as used in the present specification refers to a region where the first exterior material 11 and the second exterior material 12 overlap each other in a broad sense, and refers to a region where a part of the first exterior material 11 and a part of the second exterior material 12 overlap each other in a narrow sense. The term “overlapping each other” refers to a state where a principal surface of one exterior material and a principal surface of the other exterior material face each other directly or adjacently. That is, when a resin, a metal, or the like is interposed between the principal surface of one exterior material and the principal surface of the other exterior material, it is regarded as “overlapping each other” in the above state. The term “water vapor” as used in the present specification is not particularly limited to water in a gaseous state, and includes water in a liquid state and the like. That is, the term “water vapor” is used to broadly include matters related to water regardless of the physical state. Therefore, the “water vapor” can also be referred to as moisture or the like, and in particular, as the water in the liquid state, dew condensation water in which water in a gaseous state is condensed can also be included.

The term “extended” as used in the present specification means a state where at least a part of another independent constituent element located in a certain constituent element extends from the certain constituent element to the outside, and at least a part of the other independent constituent element is exposed to the outside. That is, “the conducting part 20 is extended from the overlapping region 50 of the exterior composite 10 to the outside” as used in the present specification indicates a state where a part of the conducting part 20 electrically connectable to the battery element 100 covered with the exterior composite 10 is exposed to the outside through between the first exterior material 11 and the second exterior material 12 forming the overlapping region 50 of the exterior composite 10 as illustrated in FIG. 5.

As illustrated in FIG. 5, the first exterior material 11, which is a constituent element of the exterior composite 10, does not need to cover the whole battery element 100, and similarly, the second exterior material 12 does not need to cover the whole battery element 100. Finally, the first exterior material 11 and the second exterior material 12 may be disposed to cover the whole battery element 100 with the first exterior material 11 and the second exterior material 12. That is, the exterior composite 10 may be finally disposed to cover the whole battery element 100. Furthermore, as illustrated in FIG. 5, the overlapping region 50 can be formed such that a part of one exterior material and a part of the other exterior material cover each other. In other words, the overlapping region 50 can be formed by laminating a part of the first exterior material 11 and a part of the second exterior material 12 each other. A direction in which the first and second exterior materials are laminated in the overlapping region 50 is a direction substantially perpendicular to a lamination direction of a positive electrode layer 110, a negative electrode layer 120, and a solid electrolyte layer 130 in the battery element 100. Furthermore, a direction in which the conducting part 20 is extended from the overlapping region 50 to the outside is substantially perpendicular to the direction in which the first and second exterior materials are laminated in the overlapping region 50, and on the other hand, is substantially parallel to the lamination direction of the positive electrode layer 110, the negative electrode layer 120, and the solid electrolyte layer 130 of the battery element 100. By adopting such a configuration, as in the solid state battery 200 of FIG. 5, the first exterior material 11 can be interposed between most of the tab lead 22 constituting the conducting part 20 excluding a connection part with the end face electrode 21 and the battery element 100. In other words, the tab lead 22 can be connected to the end face electrode 21 while the tab lead 22 and the battery element 100 are separated from each other by the first exterior material.

As described above, in the solid state battery 200 according to an embodiment of the present description, the conducting part 20 is extended from the overlapping region 50 of the exterior composite 10 to the outside. With such a configuration, the following technical effects can be achieved.

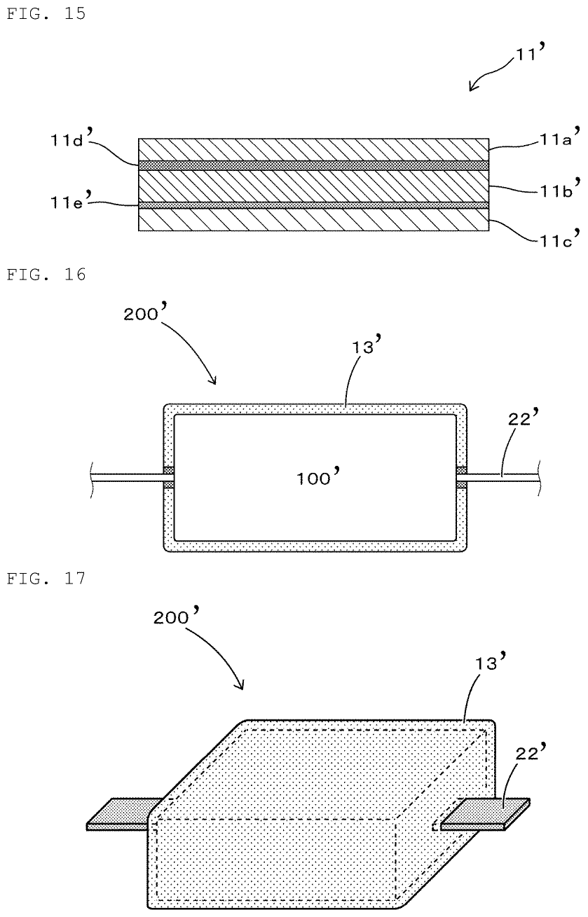

When water vapor enters the battery element, deterioration of battery characteristics may be caused. The entry of water vapor into the battery element can be suppressed by covering a periphery of the battery element with an exterior material as a water vapor transmission preventing layer. In this regard, as illustrated in FIGS. 16 and 17, in a conventional solid state battery 200′, a single exterior material 13′ is configured to cover a battery element 100′ by one circumference in sectional view. In order to extract electricity from the battery element 100′ to the outside, a tab lead 22′, which is a constituent element of a conducting part, may be connected to the battery element 100′ across the exterior material 13′. In other words, the tab lead 22′ is configured to protrude outward across the exterior material 13′. In such a configuration, since the tab lead 22′ crosses the exterior material 13′, a minute gap is generated between the tab lead 22′ and the exterior material 13′, and the gap may be a passage through which water vapor passes from the outside to the battery element 100′.

In this regard, in the solid state battery 200 according to an embodiment of the present description, as illustrated in FIGS. 5 and 6, the conducting part 20 connected to the battery element 100 is extended from the overlapping region 50 to the outside. Therefore, as compared with the conventional solid state battery 200′ covered with the single exterior material 13′ (that is, there is no overlapping region), in the extending direction (longitudinal direction) of the overlapping region 50 in sectional view, a path length from the outside of the battery to the battery element 100 can be increased by a length of the overlapping region 50. As a result, water vapor 40 can be favorably suppressed from reaching the battery element 100 from the outside as compared with the conventional solid state battery 200′.

Furthermore, as can be seen from the above description, in the overlapping region 50, one exterior material and the other exterior material overlap each other. That is, the overlapping region 50 is a region including two or more exterior materials. Therefore, a thickness of the overlapping region 50 is thicker than a thickness of the exterior composite 10 in other parts other than the overlapping region 50. This makes it possible to increase the thickness of the exterior material in the overlapping region 50 as compared with the conventional solid state battery 200′ covered with the single exterior material 13′ (that is, there is no overlapping region) in a thickness direction (transverse direction) of the overlapping region 50 in sectional view. Therefore, as compared with the conventional solid state battery 200′, it is possible to favorably suppress the water vapor 40 from reaching the battery element 100 from the outside.

When these exterior materials easily transmit water vapor (moisture, gas (carbon dioxide), and the like), the water vapor enters the inside of the battery element, and the positive electrode layer, the negative electrode layer, and the solid electrolyte layer suction and absorb the water vapor, which may deteriorate battery performance. In view of the above, a water vapor transmission rate of the exterior material in a thickness direction may be, for example, less than 5.0×10⁻³ g/(m²·day), preferably 0 to less than 5.0×10⁻³ g/(m²·day). Note that the “water vapor transmission rate” mentioned herein refers to a transmission rate obtained by an MA method under measurement conditions of 85° C. and 85% RH using a gas transmission rate measuring device of model WG-15S manufactured by MORESCO Corporation.

Alternatively, a value of the water vapor transmission rate obtained under the measurement conditions of 40° C., 90% RH, and a differential pressure of 1 atm using a gas transmission rate measuring device of model GTms-1 manufactured by Advanced Riko Co., Ltd. may be less than 1.0×10⁻³ g/(m²·day).

As illustrated in FIG. 5, the exterior composite 10 has the overlapping region 50 formed by the first exterior material 11 and the second exterior material 12 overlapping each other. In an embodiment of the present description, as illustrated in FIG. 5, the overlapping region 50 may be achieved by providing the second exterior material 12 to cover the first exterior material 11. In this case, the first exterior material 11 is located relatively inside the overlapping region 50 and the second exterior material 12 is located relatively outside the overlapping region 50 based on the position of the battery element 100. In the positioning of the first exterior material 11 and the second exterior material 12, the first thermoplastic resin layer 11a or the second thermoplastic resin layer 11c of the first exterior material 11 and the first thermoplastic resin layer 12a or the second thermoplastic resin layer 12c of the second exterior material 12 face each other.

The term “facing” as used herein means that the layer and the layer face each other, and for example, as illustrated in FIG. 7, means that the second thermoplastic resin layer 11c of the first exterior material 11 and the second thermoplastic resin layer 12c of the second exterior material 12 face each other.

In the present description, examples of the facing aspect in which the first thermoplastic resin layer 11a or the second thermoplastic resin layer 11c of the first exterior material 11 and the first thermoplastic resin layer 12a or the second thermoplastic resin layer 12c of the second exterior material 12 in the overlapping region 50 face each other include the following patterns.

### (Facing Aspect 1)

The first thermoplastic resin layer 11a of the first exterior material 11 and the first thermoplastic resin layer 12a of the second exterior material 12 face each other.

### (Facing Aspect 2)

The second thermoplastic resin layer 11c of the first exterior material 11 and the second thermoplastic resin layer 12c of the second exterior material 12 face each other.

### (Facing Aspect 3)

The first thermoplastic resin layer 11a of the first exterior material 11 and the second thermoplastic resin layer 12c of the second exterior material 12 face each other.

### (Facing Aspect 4)

The second thermoplastic resin layer 11c of the first exterior material 11 and the first thermoplastic resin layer 12a of the second exterior material 12 face each other.

Among the facing aspects 1 to 4, from the viewpoint of facilitating temperature control during thermal fusion and/or from the viewpoint of further facilitating thermal fusion between the thermoplastic resins, the solid state battery of the present description may have the facing aspects 1 and 2.

Among the first thermoplastic resin layer and the second thermoplastic resin layer included in each of the first exterior material 11 and the second exterior material 12, thermoplastic resin layers having a relatively low melting point preferably face each other in the overlapping region 50. For example, it is preferable that thermoplastic resin layers having a relatively low melting point are in contact with each other in the overlapping region 50. By adopting such a form, when the overlapping region 50 is heated using an external heat source, only the facing thermoplastic resin layers having a relatively low melting point can be softened and thermally fused; on the other hand, the thermoplastic resin layers not facing each other (that is, on the outermost side) and having a relatively high melting point can maintain their shapes without being softened. As a result, it is possible to maintain the shape of the whole solid state battery 200 while thermally fusing the portion where the first exterior material 11 and the second exterior material 12 face each other in the overlapping region 50. In the first exterior material 11, the difference between the melting point of the first thermoplastic resin layer 11a and the melting point of the second thermoplastic resin layer 11c may be 20° C. or more. In the second exterior material 12, the difference between the melting point of the first thermoplastic resin layer 12a and the melting point of the second thermoplastic resin layer 12c is preferably 20° C. or more. By adopting such an aspect, the resin layers of one side are more easily thermally fused to each other. In the case of the above aspect, in the first exterior material 11, the melting point of the second thermoplastic resin layer 11c may be lower than the melting point of the first thermoplastic resin layer 11a. In the second exterior material 12, the melting point of the second thermoplastic resin layer 11c may be lower than the melting point of the first thermoplastic resin layer 11a.

The melting point of the thermoplastic resin layer having a relatively low melting point is preferably lower than the melting point of the thermoplastic resin layer having a relatively high melting point by 20° C. or more. By adopting such a form, only the facing thermoplastic resin layers having a relatively low melting point are easily thermally fused to each other.

From the viewpoint of further facilitating thermal fusion, the melting point of the thermoplastic resin layer having a relatively low melting point may be lower than the melting point of the thermoplastic resin layer having a relatively high melting point by preferably 40° C. or more, and more preferably 60° C. or more. Meanwhile, from the viewpoint of facilitating temperature management at the time of thermal lamination during manufacturing the exterior material, the melting point of the thermoplastic resin layer having a relatively low melting point may be lower than the melting point of the thermoplastic resin layer having a relatively high melting point by 120° C. or less, preferably 100° C. or less, and more preferably 90° C. or less. Note that the “thermoplastic resin layer having a relatively low melting point” may be the “second thermoplastic resin layer”, and the “thermoplastic resin layer having a relatively high melting point” may be the “first thermoplastic resin layer”.

Since the thermoplastic resin of the exterior material according to an embodiment of the present description itself has adhesiveness, it is not always necessary to provide a sealant in the conducting part 20 located in the overlapping region 50. That is, the first thermoplastic resin layer 11a of the first exterior material 11 may be bonded directly to one principal surface of the conducting part 20, and the first thermoplastic resin layer 12a of the second exterior material 12 may be bonded directly to the other principal surface of the conducting part 20. That is, it is possible to adopt a sealant-free form. Alternatively, the second thermoplastic resin layer 11c of the first exterior material 11 may be bonded directly to one principal surface of the conducting part 20, and the second thermoplastic resin layer 12c of the second exterior material 12 may be bonded directly to the other principal surface of the conducting part 20. By adopting such a form, entry of water vapor into the solid state battery 200 through the sealant can be suppressed. Since a sealant is not used, the thickness of the exterior composite 10 in the overlapping region 50 can also be reduced, which contributes to reduction of the size of the solid state battery 200.

When a sealant is provided in the conducting part 20 located in the overlapping region 50, as illustrated in FIG. 10, a sealant 24 may be provided in the conducting part 20 located in the overlapping region 50.

Due to the presence of the sealant 24, the conducting part 20 located in the overlapping region 50 and the two exterior materials 11 and 12 constituting the overlapping region 50 can be bonded. As a result, in the overlapping region 50, the conducting part 20 and the two exterior materials 11 and 12 can be surface-bonded to each other in sectional view, and the shape of the solid state battery 200 can be more easily maintained.

The sealant 24 is not particularly limited as long as the adhesive force of the sealant does not change before and after a reflow step. For example, the sealant 24 may contain a resin having a melting point higher than the peak temperature during lead-free solder reflow.

The solid state battery according to an embodiment of the present description may further adopt the following aspect.

In one aspect, the conducting part 20 may be provided so as to be sandwiched between the first exterior material 11 and the second exterior material 12 constituting the exterior composite 10 (see FIGS. 5 to 8 and the like). Specifically, the first exterior material 11 is in contact with the conducting part 20, the second exterior material 12 is in contact with the conducting part 20, and in this state, the conducting part 20 is sandwiched between the first exterior material 11 and the second exterior material 12. In another aspect, as illustrated in FIG. 5, the conducting part 20 may be provided between an outer surface of the first exterior material 11 and an inner surface of the second exterior material 12. In such a configuration, the conducting part 20 is sandwiched between the first exterior material 11 and the second exterior material 12 so as to be substantially parallel to the first exterior material 11 and the second exterior material 12.

That is, the conducting part 20 may be positioned between the first exterior material 11 and the second exterior material 12, and the conducting part 20, the first exterior material 11, and the second exterior material 12 may be integrated. By adopting such a configuration, since the exterior materials are positioned on both sides of the conducting part 20 in sectional view, the conducting part 20 can be brought into surface contact with each other by the two exterior materials, and a minute gap between the conducting part 20 and each exterior material can be suitably reduced. As a result, the water vapor can be suitably suppressed from passing through the overlapping region 50.

Note that, from the viewpoint of suppressing water vapor from passing through the overlapping region 50 on both the positive electrode side and the negative electrode side, two overlapping regions 50 may be provided in sectional view. Specifically, one that sandwiches the conducting part on the positive electrode side (corresponding to the tab lead 22) and one that sandwiches the conducting part on the negative electrode side (corresponding to the tab lead 22) may be provided.

In one aspect, the end face electrode of the conducting part 20 and the exterior composite 10 are preferably provided along a contour surface of the battery element 100 (see FIGS. 5 to 12 and the like).

In the present specification, the “contour surface of the battery element 100” means a surface that defines the shape or appearance of the battery element 100. In the present specification, “the end face electrode of the conducting part 20 and the exterior composite 10 are provided along the contour surface of the battery element 100” means a state where the end face electrode of the conducting part 20 and the exterior composite 10 are provided substantially parallel to an extending direction of the contour surface of the battery element 100.

That is, it is preferable that the end face electrode of the conducting part 20 and the exterior composite 10 extend in substantially the same direction as the extending direction of the contour surface of the battery element 100. In the present specification, the “extending direction of the contour surface of the battery element 100” means a direction in which the contour surface advances in the longitudinal direction. The conducting part 20 and the exterior composite 10 only need to extend at least at a glance in substantially the same direction as the extending direction of the contour surface of the battery element 100, and the end face electrode of the conducting part 20 and the exterior composite 10 do not necessarily need to extend in exactly the same direction as the extending direction of the contour surface of the battery element 100. For example, due to a positional relationship among the conducting part 20, the exterior composite 10, and the battery element 100, there may be a part where a part of the conducting part 20 and a part of the exterior composite 10 do not extend substantially in the same direction and parallel to the extending direction of the contour surface of the battery element 100.

In the conventional solid state battery 200′, as described above, the tab lead 22′, which is a constituent element of the conducting part, is configured to cross the exterior material 13′ and protrude toward the outside. Therefore, an area required for mounting in the conventional solid state battery 200′ is further required by an area of the tab lead protruding to the outside. Furthermore, since the tab lead is a part that extracts electricity from the solid state battery and does not contribute to power generation of the solid state battery, the tab lead can lead to a decrease in power generation capacity per unit area of the solid state battery according to the area of the protruding conducting part.

In this regard, in an embodiment of the present description, the conducting part 20 is extended from the overlapping region 50 where the first exterior material 11 and the second exterior material 12 overlap each other. The overlapping region 50 is a constituent element of the exterior composite 10 that covers the battery element 100, and thus may be generally in the form of a contour of the battery element 100. Therefore, the conducting part 20 extended from the overlapping region 50 can also have a structure in which the protrusion is suppressed along the contour of the battery element 100. Since the conducting part 20 (specifically, the tab lead 22) may have a structure along the contour of the battery element 100 instead of the protruding structure, the solid state battery 200 according to an embodiment of the present description can be surface-mounted on an electronic substrate as a whole.

In one aspect, it is preferable that an extended part (corresponding to the tab lead 22) of the conducting part 20 to the outside includes a bent part 20A (see FIGS. 6 to 8 and the like). The bent part herein means a bent part. The form of bending is not particularly limited, and for example, as illustrated in FIGS. 6 to 8, the extended part of the conducting part 20 to the outside may be bent so as to have a right angle part. Alternatively, the extended part to the outside of the conducting part 20 may be bent so as to have a part drawing an arc (curved shape), and specifically, may be bent along a surface of the exterior material. The form in which the tab lead 22 connected to the end face electrode 21 is extended to the outside is not particularly limited, and for example, as illustrated in FIG. 7, the tab lead 22 may be extended so as to include a U-shape in sectional view. In other words, the tab lead 22 may include a plurality of bent parts.

As illustrated in FIG. 6, the extended part (corresponding to the tab lead 22) of the conducting part 20 to the outside is connected to an electronic substrate 300 or the like when the solid state battery 200 according to an embodiment of the present description is surface-mounted. At that time, the extended part (corresponding to the tab lead 22) of the conducting part 20 to the outside can be formed in a bent form according to a mounting area of the solid state battery 200 according to an embodiment of the present description, a positional relationship between the solid state battery 200 and the electronic substrate 300, or the like, and a connection method between the solid state battery 200 and the electronic substrate 300, or the like.

The length of the conducting part 20 extended to the outside is not particularly limited as long as electricity can be taken out from the conducting part 20. From the viewpoint of suitable surface mounting of the solid state battery, the extended conducting part 20 is preferably provided such that an end part of the extended conducting part 20 is provided on at least one of the upper surface side and the lower surface side of the battery element 100 covered with the first exterior material 11 or the second exterior material 12. Specifically, it is preferable that the end part of the conducting part 20 (specifically, the tab lead 22) along the contour of the battery element 100 is provided on the upper surface side or the lower surface side of the solid state battery 200, for example, the lower surface side. As a result, the solid state batteries 200 can be mounted on the electronic substrate 300 in the same row, and the overall surface mounting area can be further reduced. Furthermore, from the viewpoint of further reducing the overall surface mounting area and more reliably achieving the surface mounting of the solid state battery 200, it is preferable that at least a part of the extended part of the conducting part 20 is in “surface” contact with a surface of the electronic substrate 300. By making contact with the “surface”, a contact area between the conducting part 20 and the electronic substrate 300 can be increased. As illustrated in FIG. 6, such a form can be achieved by providing a bent part in the extended part of the conducting part 20 such that at least a part of the extended part of the conducting part 20 to the outside is substantially parallel to the surface of the electronic substrate 300.

Note that the end part of the extended conducting part 20 is not necessarily fixed to the first exterior material 11 or the second exterior material 12, and may be a free end at which the end part can freely move. In this regard, from the viewpoint of reducing the mounting area, in one aspect, a form in which at least the end part of the extended conducting part 20 is fixed to the first exterior material 11 or the second exterior material 12 is preferable.

By adopting such a form, the end part of the extended conducting part 20 is brought into close contact along the side surface of the battery element 100, and the close contact state can be maintained. Since the part protruding from the solid state battery can be more reliably suppressed, the mounting area can be reduced.

Moreover, since the close contact state is maintained, it is possible to suitably prevent the end part of the extended conducting part 20 from being bent and deformed when a force is applied from the outside to the end part of the extended conducting part 20. As a result, the solid state battery 200 can be appropriately surface-mounted on the electronic substrate 300.

A method of fixing the end part of the extended conducting part 20 to the first exterior material 11 or the second exterior material 12 is not particularly limited. For example, the end part of the extended conducting part 20 may be fixed to the first exterior material 11 or the second exterior material 12 by thermal fusion. For example, the end part of the extended conducting part 20 may be fixed to the first exterior material 11 or the second exterior material 12 by using an adhesive. The form of the adhesive is, for example, liquid, paste, sheet, solid, or powder. The type of the adhesive is, for example, an aqueous adhesive, a chemical reaction adhesive, a solvent adhesive, or a hot melt adhesive. The adhesive is not particularly limited as long as the adhesive force of the adhesive does not change before and after a reflow step. For example, examples of a material of the adhesive include at least one selected from the group consisting of a silicone-based resin, an acrylic-based resin, an epoxy-based resin, a urethane-based resin, and the like.

As illustrated in FIG. 7, the tab lead 22 is connected to the end face electrode 21, and electricity is extracted from the battery element 100 to the outside through the tab lead 22. The method of connecting the tab lead 22 and the end face electrode 21 is not particularly limited as long as the tab lead 22 and the end face electrode 21 are electrically connected. For example, the tab lead 22 and the end face electrode 21 may be connected by a conductive paste or may be connected by welding.

During charging and discharging of the solid state battery 200, as ions move in the solid electrolyte layer between the positive electrode layer and the negative electrode layer, the active material contained in each electrode layer may expand and contract along the lamination direction. In particular, when the active material, that is, the electrode layer expands along the lamination direction, tensile stress acting in an upward direction and tensile stress acting in a downward direction are generated due to this. In this regard, according to the present aspect, when the solid state battery 200 is surface-mounted on the electronic substrate 300, a minute space can be provided between the solid state battery 200 and the electronic substrate 300. The presence of such a space also makes it possible to receive an expanding part of the solid state battery 200 due to expansion of the electrode layer along the lamination direction (see FIG. 9).

In one aspect, the overlapping region 50 may be provided along a side surface of the battery element 100. The overlapping region may be provided along the whole side surface of the battery element 100 (see FIGS. 6 to 9 and the like). The term “side surface” as used in the present specification means a surface extending in a direction relatively perpendicular to an upper surface or a lower surface among surfaces constituting the battery element 100. As can be seen from the above description, there are a plurality of the “side surfaces” depending on the form of the battery element 100. Therefore, the term “overlapping region is provided along the side surface of the battery element 100” as used in the present description means that the overlapping region is provided with respect to a surface of the battery other than the upper surface or the lower surface of the battery element 100.

With such a configuration, since the overlapping region 50 does not protrude from the battery element 100, a mounting area required for surface mounting is reduced. In particular, when the end part of the conducting part 20 (specifically, the tab lead 22) along the contour of the battery element 100 is provided on the upper surface side or the lower surface side of the solid state battery 200, for example, the lower surface side, a part other than the end part of the conducting part 20 (specifically, the tab lead 22) can be accommodated in the overlapping region 50 along the side surface of the battery element 100, and it is possible to suitably achieve both surface mounting of the solid state battery 200 on the electronic substrate 300 and suppression of entry of water vapor into the battery.

From the viewpoint of preventing water vapor from entering the battery element 100, the overlapping region 50 may be wide. Specifically, in sectional view, it is more preferable as a length of the overlapping region 50 along a longitudinal direction of the tab lead 22 is longer. The length of the overlapping region 50 may be 10% or more, preferably 20% or more, 30% or more, and more preferably 40% or more with respect to a height of the battery element 100 (that is, a length from an upper surface to a lower surface of the battery element 100). Furthermore, from the viewpoint of facilitating adjustment of the position and length of the conducting part 20 extended to the outside, the length of the overlapping region 50 may be 150% or less, preferably 100% or less, more preferably 80% or less, still more preferably 70% or less, and particularly preferably 60% or less, with respect to the height of the battery element 100. The length of the overlapping region 50 may not be uniform over the entire overlapping region 50. For example, as illustrated in sectional view of FIG. 12, the lengths of the overlapping regions 50 may be different.

In one aspect, the first exterior material 11 and the second exterior material 12 include the metal layer 11b and the metal layer 12b as intermediate layers (see FIG. 7). When the battery element 100 is covered with the first exterior material 11, the metal layer 11b, which is an intermediate layer of the exterior material, is electrically connected to the end face electrode 21 on a positive electrode side and the end face electrode 21 on a negative electrode side, and an insulating material may be provided on the end face of the exterior material from the viewpoint of preventing occurrence of a short circuit through the metal layer 11b. The method of an insulation treatment for providing the insulating material is not particularly limited, and any method may be used as long as it contributes to preventing a short circuit of the battery element 100 via the exterior material.

Note that the positional relationship between the conducting part 20 and the overlapping region 50 is not particularly limited until confirmation, and any structure may be used according to the form of surface mounting. For example, a structure as illustrated in FIGS. 11 and 12 can be adopted. As an example, in the structure of FIG. 11, the exposed parts of the conducting parts 20 on the positive electrode side and the negative electrode side are positioned so as to face each other with the battery element 100 interposed therebetween. As a result, the conducting part 20 on the positive electrode side and the conducting part 20 on the negative electrode side of the solid state battery 200 are positioned to be more distant from each other, so that the possibility that both electrodes are short-circuited can be reduced. Furthermore, as illustrated in FIG. 12, the design of the overlapping regions on the positive electrode side and the negative electrode side and the design of the tab lead 22 can be appropriately changed asymmetrically depending on a mounting destination of the solid state battery 200. This enables flexible surface mounting according to a surface form of the surface mounting destination of the solid state battery 200.

Furthermore, the thickness of the overlapping region 50 is determined by the thicknesses of the first exterior material 11 and the second exterior material 12 forming the overlapping region.

The thickness of the overlapping region is preferably 2 μm to 1000 μm, more preferably 4 μm to 600 μm, and still more preferably 6 μm to 200 μm, and may be, for example, 100 μm from the viewpoint of further suppressing deterioration of battery performance due to entry of water vapor into the battery element.

The solid state battery including the exterior material of the present description has been taken as an example, and a case where the exterior material of the present description is applied to the solid state battery has been described in detail. The aspects of the various solid state batteries described above can also be applied to other electronic devices as shown in the following embodiments.

### Third Embodiment

For example, as illustrated in FIG. 13, the exterior material according to an embodiment of the present description can be applied to a circuit board (or a composite module or the like) 610 including a plurality of electronic devices (such as a capacitor, a resistor, a coil, a diode, and a transistor). FIG. 13 illustrates a packaged circuit board 600, and the packaged circuit board 600 is configured by covering the circuit board 610 with the exterior composite 10 including the first exterior material 11 and the second exterior material 12.

### (Method for Manufacturing Solid State Battery of Present Description)

A method for manufacturing the solid state battery according to an embodiment of the present description will be described below. Hereinafter, as the solid state battery including the exterior material of the present description, a method for manufacturing a solid state battery of the first embodiment and a method for manufacturing a solid state battery of the second embodiment will be described. These manufacturing methods are merely examples of a method for manufacturing a solid state battery including the exterior material of the present description, and do not limit the present description.

First, the manufacturing method of the second embodiment will be described before describing the manufacturing method of the first embodiment.

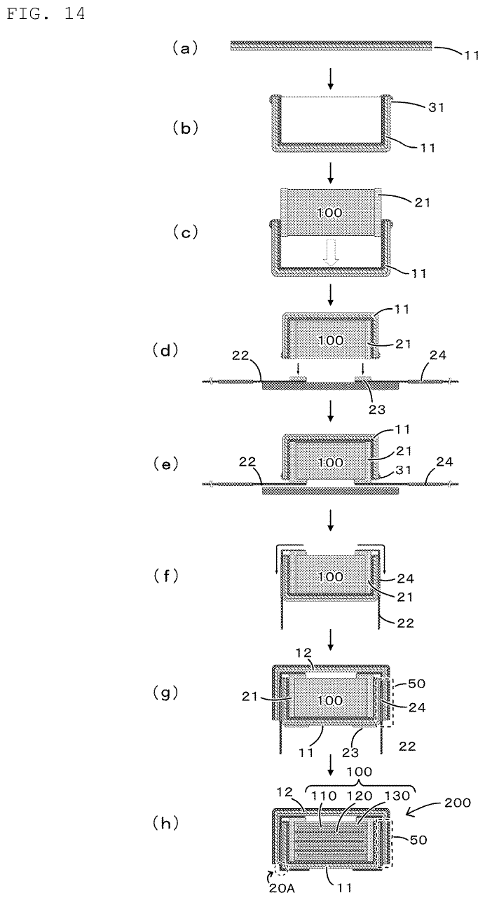

The method for manufacturing of a solid state battery according to an embodiment of the present description (second embodiment) roughly includes the following steps (i) to (iv) in order (see FIGS. 14(a) to 14(h)). Specifically, the method for manufacturing a solid state battery according to an embodiment of the present description includes the steps of: (i) preparing the battery element 100 including the positive electrode layer 110, the negative electrode layer 120, and the solid electrolyte layer 130 interposed between the positive electrode layer 110 and the negative electrode layer 120; (ii) providing the first exterior material 11 to cover a part of the battery element 100; (iii) providing the conducting part 20 capable of extracting electricity from the battery element 100 to the outside; and (iv) providing the second exterior material 12 to cover a remaining part other than the part of the battery element 100.

In particular, the method for manufacturing a solid state battery according to an embodiment of the present description is characterized in that the overlapping region 50 in which the first exterior material 11 and the second exterior material 12 overlap each other is formed, and the second exterior material 12 is provided so that the conducting part 20 is extended from the overlapping region 50 to the outside.

The first exterior material 11 and the second exterior material 12 each include a metal layer, a first thermoplastic resin layer located on a first principal surface side of the metal layer, and a second thermoplastic resin layer located on a second principal surface side of the metal layer, in which a melting point of the first thermoplastic resin layer and a melting point of the second thermoplastic resin layer are both higher than 260° C.

Hereinafter, for better understanding of the present description, one manufacturing method will be exemplified and described, but the present description is not limited to this method. Furthermore, temporal matters such as the following description order are merely for convenience of description, and are not necessarily limited thereto.

### [Preparation of First Exterior Material]

First, as illustrated in FIG. 14(a), the first exterior material 11 of the present description is prepared. The first exterior material 11 includes the metal layer 11b, the first thermoplastic resin layer 11a located on the first principal surface side of the metal layer 11b, and the second thermoplastic resin layer 11c located on the second principal surface side of the metal layer 11b. The first exterior material 11 may be prepared by being produced according to the above (Method for Manufacturing Exterior Material of Present Description).

### [Deep Drawing Processing of First Exterior Material]

Next, as illustrated in FIG. 14(b), the first exterior material 11 is subjected to drawing processing to be molded into a shape covering the battery element 100. The drawing processing is not particularly limited as long as it is a processing method in which the first exterior material 11 is processed into a concave shape (or a cup shape) by applying pressure to form a shape in which the first exterior material 11 covers the battery element 100. For example, the first exterior material 11 is placed on a box-shaped mold along the shape of the battery element 100, and pressure is applied from above the first exterior material 11 by a mold imitating the shape of the battery element 100, thereby molding the first exterior material 11 covering the battery element 100. The present description is not limited thereto, and the battery element 100 may be pressed against the first exterior material 11 to perform drawing processing.

### [Attachment of First Exterior Material 11]

Next, as illustrated in FIG. 14(c), the battery element 100 is inserted into the first exterior material 11 obtained by the above method, and the first exterior material 11 is attached to the battery element 100. Specifically, the first exterior material is covered such that a part of the upper surface or a part of the lower surface of the battery element 100 is exposed. In a preferred aspect, the first exterior material is attached to cover a surface other than the upper surface or the lower surface of the battery element 100. More specifically, the first exterior material 11 is attached such that the end face of the first exterior material is located at a boundary between the upper surface and the side surface of the battery element 100. Note that the end face electrode 21 may be previously attached to the side surface of the battery element 100.

The end face of the first exterior material 11 may be provided with an insulating material 31 to prevent a short circuit of the battery element 100. The insulating material 31 is not particularly limited as long as it has electrical insulation, and may be, for example, an insulating resin. Examples of a material of the insulating resin include at least one selected from the group consisting of an epoxy-based resin, an acrylic-based resin, a phenol-based resin, and a synthetic rubber.

### [Attachment of Tab Lead 22]

Next, as illustrated in FIGS. 14(d) and 14(e), the tab lead 22 is attached to the end face electrode 21 provided on the battery element 100 that is not covered with the first exterior material 11. Preferably, a conductive adhesive 23 is applied to the end part of the tab lead 22 by metal mask printing, so that the end part of the tab lead 22 and the end face electrode 21 of the battery element 100 are attached to electrically connect to each other. The conductive adhesive 23 may be a conductive paste, and is made of, for example, a resin material containing a conductive filler. Examples of the conductive filler include at least one selected from the group consisting of nickel, copper, aluminum, gold, carbon, and the like, and examples of the resin material include at least one selected from the group consisting of an epoxy-based resin, an acrylic-based resin, a silicone-based resin, a urethane-based resin, and the like.

Next, as illustrated in FIG. 14(f), the tab lead 22 is positioned along the contour surface of the side surface of the battery element 100 with the end part of the tab lead 22 connected to the end face electrode 21 of the battery element 100 as a base point. When the tab lead 22 is disposed along the side of the battery element 100, the tab lead 22 may be bent.

### [Attachment of Second Exterior Material 12]

Next, the second exterior material 12 is prepared. The second exterior material 12 includes the metal layer 12b, the first thermoplastic resin layer 12a located on the first principal surface side of the metal layer 12b, and the second thermoplastic resin layer 12c located on the second principal surface side of the metal layer 12b. The second exterior material 12 may be prepared by being produced according to the above (Method for Manufacturing Exterior Material of Present Description). As illustrated in FIG. 14(g), after the tab lead 22 is positioned so as to follow the contour surface of the side surface of the battery element 100, the second exterior material 12 is disposed on the surface side of the battery element 100 that is not covered with the first exterior material 11. Thereafter, the end part of the second exterior material 12 is disposed along the side surface of the battery element 100. At this time, since the end part of the first exterior material 11 is already disposed on the side surface of the battery element 100, the overlapping region 50 in which the second exterior material 12 and the first exterior material 11 overlap is formed. Specifically, a layer in which the battery element 100, the first exterior material 11, the tab lead 22, and the second exterior material 12 are arranged in this order is formed from the battery element 100 toward the outside, and the tab lead 22 is extended from the overlapping region 50. In other words, the conducting part 20 including the end face electrode 21 and the tab lead 22 is extended from the overlapping region to the outside.

Note that, in the overlapping region 50, the first exterior material 11 and the second exterior material 12 are preferably disposed on the battery element 100 such that the first thermoplastic resin layer of the first exterior material 11 and the first thermoplastic resin layer of the second exterior material 12 face each other. In the overlapping region 50, the thermoplastic resins facing each other preferably have a relatively low melting point.

From the viewpoint of preventing water vapor from entering the battery element 100, the first exterior material 11 located in the overlapping region 50, the tab lead 22 as a constituent element of the conducting part 20, and the second exterior material 12 may be brought into a close contact state. The method of bringing into close contact is not particularly limited, but can be brought into close contact by thermal fusion, mechanical bonding, pressure bonding, welding, an adhesive, or the like.

In the case of thermal fusion, for example, in FIG. 14(g) or FIG. 14(h), the overlapping region 50 may be heated by using an external heat source, and the first exterior material 11 and the second exterior material 12 may be thermally fused to the tab lead 22. Alternatively, in FIG. 14(e) or FIG. 14(f), the tab lead 22 may be heated, and the first exterior material 11 and the second exterior material 12 may be bonded to the heated tab lead 22 and thermally fused. In another aspect, from the viewpoint of more improving the close contact state between the first exterior material 11, the tab lead 22, and the second exterior material 12, the sealant 24 may be applied to the tab lead 22 in advance, and the sealant 24 may be provided to the overlapping region 50. For example, the sealant 24 is not particularly limited as long as the adhesive force of the sealant 24 does not change before and after a reflow step. For example, the sealant 24 may contain a resin having a melting point higher than the peak temperature during reflow. Note that, since the first thermoplastic resin layer 11a and the second thermoplastic resin layer 11c constituting the exterior material of the present description themselves have improved adhesiveness, first thermoplastic resin layer 11a and the second thermoplastic resin layer 11c can be bonded to the tab lead 22 without using the sealant 24. In the case of using the sealant 24, a sealant having a smaller thickness than before can be used.

### [Fixing of Tab Lead 22]

Finally, as illustrated in FIG. 14(h), the tab lead 22 whose one end is a free end, that is, the end part (that is, the end part of the extended conducting part 20) of the tab lead 22 which is not connected to the battery element 100 is positioned along the contour surface of the battery element 100. Specifically, the tab lead 22 is bent so as to be in contact with the first exterior material 11. At this time, the tab lead 22 may be thermally fused to the first exterior material 11 by heating the part where the tab lead 22 and the first exterior material 11 are in contact with each other. An adhesive or the like may be applied to a part where the tab lead 22 and the first exterior material 11 are in contact with each other to bond and fix the tab lead 22 and the first exterior material 11 to each other. The adhesive is not particularly limited as long as the adhesive force of the sealant 24 does not change before and after a reflow step.

The solid state battery 200 according to an embodiment of the present description can be finally obtained through such a step (FIG. 14(h)). Note that the bending of the tab lead 22 and the adhesion fixation to the first exterior material in the [Fixing of Tab Lead 22] may be performed, for example, immediately before the solid state battery 200 of the present description is surface-mounted on the electronic substrate 300. Specifically, after manufacturing until the state of FIG. 14(g) is obtained, the manufacturing may be temporarily stopped before the tab lead 22 is fixed, and the state of FIG. 14(g) may be temporarily stored. Design items such as presence or absence of bending of the tab lead 22, a length of a part from which the tab lead 22 is extended, a bonding and fixing position of the tab lead 22, a bending part, and a bending direction may be appropriately determined according to a shape and the like of the electronic substrate to be surface-mounted thereafter. By adopting such a step, the solid state battery 200 of the present description can be flexibly surface-mounted according to the shape of the electronic substrate.

In the finally obtained solid state battery 200 according to an embodiment of the present description, the following operational effects can be exhibited.

Specifically, in the obtained solid state battery 200 according to an embodiment of the present description, the conducting part 20 connected to the battery element 100 is extended from the overlapping region 50 to the outside. Therefore, as compared with the conventional solid state battery 200′ covered with the single exterior material 13′ (that is, there is no overlapping region), in the extending direction (longitudinal direction) of the overlapping region 50 in sectional view, a path length from the outside of the battery to the battery element 100 can be increased by a length of the overlapping region 50. As a result, water vapor 40 can be favorably suppressed from reaching the battery element 100 from the outside as compared with the conventional solid state battery 200′.

Furthermore, as can be seen from the above description, in the overlapping region 50, one exterior material and the other exterior material overlap each other. That is, the overlapping region 50 is a region including two or more exterior materials. Therefore, a thickness of the overlapping region 50 is thicker than a thickness of the exterior composite 10 in other parts other than the overlapping region 50. This makes it possible to increase the thickness of the exterior material in the overlapping region 50 as compared with the conventional solid state battery 200′ covered with the single exterior material 13′ (that is, there is no overlapping region) in a thickness direction (transverse direction) of the overlapping region 50 in sectional view. Therefore, as compared with the conventional solid state battery 200′, it is possible to favorably suppress the water vapor 40 from reaching the battery element 100 from the outside.

Furthermore, the method for manufacturing a solid state battery according to an embodiment of the present description (first embodiment) roughly includes the following steps (i) to (iv) in order (see FIGS. 14(a) to 14(h)). Specifically, the method for manufacturing a solid state battery according to an embodiment of the present description includes the steps of: (i) preparing the battery element 100 including the positive electrode layer 110, the negative electrode layer 120, and the solid electrolyte layer 130 interposed between the positive electrode layer 110 and the negative electrode layer 120; (ii) providing the end face electrode 21 capable of extracting electricity from the battery element 100 to the outside; and (iii) providing the exterior material 11 to cover a part of the battery element 100.

The exterior material 11 includes a metal layer 11b, a first thermoplastic resin layer 11a located on a first principal surface side of the metal layer 11b, and a second thermoplastic resin layer 11c located on a second principal surface side of the metal layer 11b, in which a melting point of the first thermoplastic resin layer 11a and a melting point of the second thermoplastic resin layer 11c are both higher than 260° C.

First, as described in [Preparation of First Exterior Material] of <Second Embodiment>, the exterior material 11 is prepared (FIG. 14(a)). Next, as described in [Deep Drawing Processing of Exterior Material 11] of <Second Embodiment>, the exterior material 11 is processed into a concave shape (or a cup shape) (FIG. 14(b)). Next, the battery element 100 including the end face electrode 21 is inserted into the first exterior material 11 processed into a concave shape, and the exterior material 11 is attached to the battery element 100 (FIG. 14(c)).

The tab lead 22 is attached to the end face electrode 21. Next, the exterior material 11 is attached to cover the battery element 100 to which the exterior material 11 processed into a concave shape is attached (to a portion of the remaining battery element 100 not covered with the exterior material 11 having a concave shape). At this time, the exterior material 11 is attached such that the tab lead 22 attached to the end face electrode 21 is exposed to the outside. Through the above steps, the solid state battery of the first embodiment is obtained.

While an embodiment of the present description has been described above, a typical example in the applicable scope of the present description has been merely provided. Accordingly, a person skilled in the art will easily understand that the present description is not limited thereto, and various modifications can be made.

### EXAMPLES

Table 1 shows the configurations of the exterior materials of Examples 1 to 5 and Comparative Example 1 and the evaluation results of the solid state battery including each of these exterior materials.

### Example 1

### (Production of First Exterior Material)

A first exterior material was produced as follows.

First, a highly heat-resistant polyamide having a melting point of 305° C. was thermally fused to one surface of an aluminum foil at a temperature of 290° C. by a thermal lamination method to produce an integrated product of the aluminum foil and the highly heat-resistant polyamide. Subsequently, polyethylene naphthalate having a melting point of 269° C.) was thermally fused to the other surface of the aluminum foil of the integrated product at a temperature of 255° C. to produce a first exterior material.

### (Production of Second Exterior Material)

A second exterior material was produced by the same method as in the first exterior material.

### (Preparation of Battery Element)

A battery element including a positive electrode layer, a negative electrode layer, and a solid electrolyte layer interposed between the positive electrode layer and the negative electrode layer was prepared, and an end face electrode capable of extracting electricity from the battery element to the outside was provided.

### (Molding of Exterior Material)

The first exterior material and the second exterior material were subjected to drawing processing to mold the first exterior material and the second exterior material into a cup shape. In the molding, molding was performed such that the outside of the cup-shaped first exterior material was a thermoplastic resin layer having a relatively low melting point, and the inside of the cup-shaped second exterior material was a thermoplastic resin layer having a relatively low melting point. As a result, in an overlapping region to be formed later, thermoplastic resin layers having a relatively low melting point were made to face each other.

A cup-shaped first exterior material was attached to a battery element provided with an end face electrode. Next, a tab lead was attached to the end face electrode exposed to the outside on the side not covered with the first exterior material 11. The tab lead attached to the end face electrode was positioned along the contour surface of the side surface of the battery element. Next, a cup-shaped second exterior material was attached to cover the surface of the battery element not covered with the cup-shaped first exterior material. As a result, an overlapping region in which the second exterior material and the first exterior material overlap each other was formed on the side surface of the battery element. The overlapping region was heated to thermally fuse and seal the first exterior material and the second exterior material in the overlapping region. As a result, a solid state battery covered with the exterior material was obtained.

### Examples 2 to 5

Examples 2 to 5 were obtained by the same method as in Example 1, except that the thermoplastic resin layer described in each of Examples 2 to 5 of Table 1 was used.

### Comparative Example 1

Comparative Example 1 was obtained by the same method as in Example 1, except that the thermoplastic resin layer described in Comparative Example 1 of Table 1 was used.

### <Evaluation of Surface Mounting>

The solid state battery covered with the exterior material was mounted on a circuit board (FR4) by using a solder paste. The surface mountability was evaluated according to JIS C60068-2-58. The evaluation results thereof are shown in Table 1.

### <Evaluation of Deterioration of Battery Element by Water Vapor>

After the solid state battery covered with the exterior material was mounted on a circuit board (FR4) by using a solder paste, characteristics were evaluated under a high temperature and high humidity of 60° C. and 90% RH and an environment of 60° C. and 50% RH. The evaluation results thereof are shown in Table 1.

TABLE 1

| | Configuration of exterior material | | | |
|---|---|---|---|---|
| | | | | Difference between melting point of |
| | First thermoplastic resin | Metal layer | Second thermoplastic resin | first thermoplastic resin layer and |
| | layer | Melting | layer | melting point of second thermoplastic |
| | Melting point [° C.] | point [° C.] | Melting point [° C.] | resin layer [° C.] |
| Example 1 | Highly heat-resistant | Al | Polyethylene naphthalate | 36 |
| | polyamide | 660° C. | (PEN) | |
| | 305 | | 269 | |
| Example 2 | Fluorine resin: PFA | | Fluorine resin: FEP | 35 |
| | 305 | | 270 | |
| Example 3 | Polyphenylene sulfide | | Polyphenylene sulfide | 20 |
| | (PPS)-A | | (PPS)-B | |
| | 280 | | 260 | |
| Example 4 | LCP-A | | LCP-B | 27 |
| | 317 | | 290 | |
| Example 5 | PEEK-A | | PEEK-B | 33 |
| | 343 | | 310 | |
| Comparative | Polypropylene resin + | Al | Polypropylene resin + | 0 |
| Example 1 | adhesive layer | 660° C. | adhesive layer | |

Evaluation results of solid state battery including exterior material

| | Surface mounting | Deterioration of battery element |
|---|---|---|
| Example 1 | Possible | None |
| Example 2 | Possible | None |
| Example 3 | Possible | None |
| Example 4 | Possible | None |
| Example 5 | Possible | None |
| Comparative | Not possible | Deterioration due to moisture in air is confirmed |
| Example 1 | | |

From the above results, it was confirmed that the solid state battery including the exterior material of the present description could be surface-mounted, and deterioration of the battery element by water vapor was not observed.

The exterior material according to an embodiment of the present description can be used for various electronic devices requiring a water vapor barrier property. Although it is merely an example, the exterior material according to an embodiment of the present description can be used for a battery (a primary battery, a secondary battery, particularly a solid state battery), a circuit board, a composite module, an electronic component, and the like. The solid state battery according to an embodiment of the present description can be used in various fields where battery use or power storage is assumed. The electronic device according to an embodiment of the present description can be used in various fields requiring electric control. By way of example only, the solid state battery according to an embodiment of the present description can be used in electric, information, and communication fields (for example, the fields of mobile devices such as cellular phones, smartphones, smartwatches, lap-top computers, digital cameras, activity meters, arm computers, and electronic papers) in which a mobile device or the like is used, home and small-size industrial applications (for example, the fields of electric tools, golf carts, domestic and nursing care, and industrial robots), large-size industrial applications (for example, the fields of forklifts, elevators, harbor cranes), transportation system fields (for example, fields such as hybrid vehicles, electric vehicles, buses, trains, power-assisted bicycles, and electric motorcycles), electric power system applications (for example, fields such as various types of electric power generation, load conditioners, smart grids, general household installation-type power storage systems), medical applications (fields of medical device such as earphone hearing aids), pharmaceutical applications (fields such as dosage management systems), IoT fields, space and deep-sea applications (for example, fields such as spacecraft and submersible research vehicles), and the like.

### DESCRIPTION OF REFERENCE SYMBOLS

10: Exterior composite
11, 11′: Exterior material, first exterior material
11a, 11a′: First thermoplastic resin layer
11b, 11b′: Metal layer
11c, 11c′: Second thermoplastic resin layer
11d′ (11e′): Adhesive layer
12: Second exterior material
12a: First thermoplastic resin layer
12b: Metal layer
12c: Second thermoplastic resin layer
13′: Single exterior material
20: Conducting part
20A: Bent part
21: End face electrode
22, 22′: Tab lead
23: Conductive adhesive
24: Sealant
31: Insulating material
40: Water vapor
50: Overlapping region
100, 100′: Battery element
110: Positive electrode layer
120: Negative electrode layer
130: Solid electrolyte layer
200, 200′: Solid state battery
300: Electronic substrate
310: Electronic substrate connection part
401: First heating roll
402: Second heating roll
501: First cooling roll
502: Second cooling roll
511a: First thermoplastic resin material
511b: Metal layer
511c: Second thermoplastic resin material
600: Packaged circuit board
610: Circuit board

1. An exterior material comprising:
a metal layer;
a first thermoplastic resin layer on a first principal surface side of the metal layer; and
a second thermoplastic resin layer on a second principal surface side of the metal layer,
wherein a first melting point of the first thermoplastic resin layer and a second melting point of the second thermoplastic resin layer are both higher than 260° C.

2. The exterior material according to claim 1, wherein at least one resin layer of the first thermoplastic resin layer and the second thermoplastic resin layer is bonded directly to the metal layer.

3. The exterior material according to claim 1, wherein a difference between the first melting point of the first thermoplastic resin layer and the second melting point of the second thermoplastic resin layer is 20° C. or more.

4. The exterior material according to claim 1, wherein the first thermoplastic resin layer and the second thermoplastic resin layer are composed of at least one thermoplastic resin selected from a liquid crystal polymer, polyethylene naphthalate, an aromatic polyether ketone-based resin, a fluorine-based resin, a polyamide-based resin, and a polyphenylene sulfide-based resin.

5. The exterior material according to claim 1, wherein the first thermoplastic resin layer and the second thermoplastic resin layer are composed of a same kind of thermoplastic resin.

6. A solid state battery comprising:
a battery element including a positive electrode layer, a negative electrode layer, and a solid electrolyte layer interposed between the positive electrode layer and the negative electrode layer;
an exterior material covering the battery element; and
a conducting part capable of extracting electricity from the battery element to an outside,
wherein the exterior material includes:
a metal layer;
a first thermoplastic resin layer on a first principal surface side of the metal layer; and
a second thermoplastic resin layer on a second principal surface side of the metal layer,
wherein a first melting point of the first thermoplastic resin layer and a second melting point of the second thermoplastic resin layer are both higher than 260° C.

7. The solid state battery according to claim 6, wherein a difference between the first melting point of the first thermoplastic resin layer and the second melting point of the second thermoplastic resin layer is 20° C. or more.

8. The solid state battery according to claim 6, wherein the second melting point of the second thermoplastic resin layer is lower than the first melting point of the first thermoplastic resin layer.

9. The solid state battery according to claim 6, wherein the exterior material comprises a first exterior material and a second exterior material that form an exterior composite and overlap each other in an overlapping region, and the conducting part extends from the overlapping region to the outside.

10. The solid state battery according to claim 9, wherein
the first exterior material is on an inside the overlapping region and the second exterior material is on an outside the overlapping region relative to the battery element, and
the first thermoplastic resin layer or the second thermoplastic resin layer of the first exterior material and the first thermoplastic resin layer or the second thermoplastic resin layer of the second exterior material face each other in the overlapping region.

11. The solid state battery according to claim 10, wherein the second thermoplastic resin layer of the first exterior material and the second thermoplastic resin layer of the second exterior material face each other in the overlapping region.

12. The solid state battery according to claim 10, wherein the first thermoplastic resin layer of the first exterior material and the first thermoplastic resin layer of the second exterior material face each other in the overlapping region.

13. The solid state battery according to claim 10, wherein
the second thermoplastic resin layer of the first exterior material is bonded directly to a first principal surface of the conducting part, and
the second thermoplastic resin layer of the second exterior material is bonded directly to a second principal surface of the conducting part.

14. The solid state battery according to claim 10, wherein
the first thermoplastic resin layer of the first exterior material is bonded directly to a first principal surface of the conducting part, and
the first thermoplastic resin layer of the second exterior material is bonded directly to a second principal surface of the conducting part.

15. The solid state battery according to claim 9, wherein a length of the overlapping region is at least 10% or more of a height of the battery element.

16. The solid state battery according to claim 9, wherein the overlapping region is along a side surface of the battery element.

17. The solid state battery according to claim 9, wherein at least an end part of the conducting part is on at least one of an upper surface side and a lower surface side of the battery element covered with the first exterior material or the second exterior material.

18. The solid state battery according to claim 9, wherein the conducting part and the exterior composite extend in a direction substantially identical with an extending direction of a contour surface of the battery element.

19. The solid state battery according to claim 6, wherein the exterior material is a continuous single structure that surrounds the battery element.

20. The solid state battery according to claim 6, wherein the exterior material is along a contour surface of the battery element.

21. The solid state battery according to claim 6, wherein a part of the conducting part that extends to the outside includes a bent part.

22. An electronic device comprising:
an electronic device; and
an exterior material covering the electronic device,
wherein the exterior material includes a metal layer, a first thermoplastic resin layer on a first principal surface side of the metal layer, and a second thermoplastic resin layer on a second principal surface side of the metal layer, and
a first melting point of the first thermoplastic resin layer and a second melting point of the second thermoplastic resin layer are both higher than 260° C.
